(19) United States
(12) Patent Application Publication
(10) Pub. No.: US 2024/0391820 A1
(43) Pub. Date: Nov. 28, 2024

(54) TEXTURED ARTICLES AND METHODS FOR MAKING THE SAME

(71) Applicant: CORNING INCORPORATED, CORNING, NY (US)

(72) Inventors: Ronghua Chen, Fuzhou City (CN); Carol Ann Click, CORNING, NY (US); Sean Patrick Coleman, Lindley, NY (US); Robert Randall Hancock, JR., CORNING, NY (US); Yuhui Jin, Painted Post, NY (US); Atul Kumar, Horseheads, NY (US); John Richard Ridge, Hammondsport, NY (US); Meng Shang, Painted Post, NY (US)

(21) Appl. No.: 18/660,658

(22) Filed: May 10, 2024

(30) Foreign Application Priority Data
May 24, 2023 (CN) 202310595566.2
Mar. 26, 2024 (CN) 202410349400.7

(51) Int. Cl. C03C 10/00; C03C 3/083; C03C 15/00; C03C 19/00

(52) U.S. Cl. CPC C03C 10/0027; C03C 3/083; C03C 15/00; C03C 19/00; C03C 2204/08

(57) ABSTRACT

A textured article is described herein that may include a glass-based substrate comprising a first major surface and a second major surface. The first major surface may be opposite the second major surface. At least a portion of the first major surface may be textured. The portion of the first major surface that is textured may have a roughness Rₐ of greater than or equal to 400 nm and an average pitch. A ratio of roughness Rₐ to average pitch may be from about 0.01 to about 0.04. At least a portion of the textured article may have an opacity of greater than about 70% or may have a coefficient of friction of from about 0.25 to about 0.4. The coefficient of friction may be measured as the kinetic coefficient of friction using a 500 g load on a foam rubber according to ASTM D1984.

### CLAIM OF PRIORITY

This application claims the benefit of priority under Rule 32 of China Patent Application No. 202310595566.2 filed May 24, 2023, and claims the benefit of priority under Rule 32 of China Patent Application No. 202410349400.7 filed Mar. 26, 2024. The entire contents of this application are hereby incorporated herein by reference for all purposes.

### BACKGROUND

### Field

The present specification generally relates to glass-based articles and, more specifically, to textured glass-based articles.

### Technical Background

Portable electronic devices, such as, smartphones, tablets, and wearable devices (such as, for example, watches and fitness trackers) utilize glass-based materials. For example, screens and back covers on such portable electronic devices may be made of glass-based materials. Additionally, other portions of the housing may include glass-based articles. Coatings and other surface treatments may be used to enhance glass-based materials. However, current glass-based materials may have optical limitations and/or poor tactile feel.

Accordingly, a need exists for glass-based materials with different optical characteristics and tactile feel, and methods of producing such materials. This need and other needs are addressed by the present disclosure.

### SUMMARY

According to one or more embodiments, a textured article may comprise a glass-based substrate comprising a first major surface and a second major surface. The first major surface may be opposite the second major surface. At least a portion of the first major surface may be textured. The portion of the first major surface that is textured may have a roughness Rₐ of greater than or equal to 400 nm and an average pitch. A ratio of roughness Rₐ to average pitch may be from about 0.01 to about 0.04. At least a portion of the textured article may have an opacity of greater than about 70% or may have a coefficient of friction of from about 0.25 to about 0.4. The coefficient of friction may be measured as the kinetic coefficient of friction using a 500 g load on a foam rubber according to ASTM D1984.

According to another embodiment, a textured article may comprise a glass-based substrate comprising a first major surface and a second major surface. The first major surface may be opposite the second major surface. At least a portion of the first major surface may be textured. The portion of the first major surface that is textured may have a roughness Rₐ of greater than or equal to 400 nm and an average pitch. A ratio of roughness Rₐ to average pitch may be from about 0.01 to about 0.04. At least a portion of the textured article may have one of the following: transmittance color coordinates in the (L*, a*, b*) colorimetry system at normal incidence under an International Commission on Illumination illuminant of L*: about 90 to about 98, a*: about −0.75 to about 0, and b*: about −2 to about 0; or transmittance color coordinates in the (L*, a*, b*) colorimetry system at normal incidence under an International Commission on Illumination illuminant of L*: about 25 to about 32, a*: about −0.5 to about 0, and b*: about −1.5 to about 0.

According to another embodiment, a method of making a textured article may comprise abrading at least a portion of a first major surface, a second major surface, or both, of a glass-based substrate to form an abraded surface by propelling abrasive particles against the surface, and etching the abraded surface with an etchant to form a textured glass-based substrate. The etchant may be an aqueous hydroxide solution with a hydroxide concentration of from about 5 wt. % to about 20 wt. %. Abrading the surface of the glass-based substrate may be with an abrasive media having an average diameter of from about 7 microns to about 70 microns.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, serve to explain the principles and operations of the claimed subject matter.

### BRIEF DESCRIPTION OF THE DRAWINGS

FIG. 1A schematically depicts a cross-sectional view of a textured article, according to one or more embodiments described herein;

FIG. 1B schematically depicts a cross-sectional view of another textured article, according to one or more embodiments described herein;

FIG. 2A is a plan view of an exemplary electronic device incorporating a textured article, according to one or more embodiments described herein;

FIG. 2B is a perspective view of the exemplary electronic device of FIG. 2A, according to one or more embodiments described herein;

FIG. 3 schematically depict a glass-based substrate in an abraded state and etched state, according to one or more embodiments described herein;

FIG. 4 graphically depicts the effect of etch temperature on etch rate on glass-based substrates, according to one or more embodiments described herein;

FIG. 5A graphically depicts the effect of particle size on the pitch of a textured glass-based substrate, according to one or more embodiments described herein;

FIG. 5B graphically depicts the effect of particle size on the pitch of a textured glass-based substrate, according to one or more embodiments described herein;

FIG. 6A graphically depicts the effect of particle size on the skewness of height distribution of the surface a textured glass-based substrate, according to one or more embodiments described herein;

FIG. 6B graphically depicts the effect of particle size on the skewness of height distribution of the surface of a textured glass-based substrate, according to one or more embodiments described herein;

FIG. 7A graphically depicts the effect of particle size on the arithmetic mean peak curvature of the surface of a textured glass-based substrate, according to one or more embodiments described herein;

FIG. 7B graphically depicts the effect of particle size on the arithmetic mean peak curvature of the surface of a textured glass-based substrate, according to one or more embodiments described herein;

FIG. 8A graphically depicts the effect of particle size on the root mean square height of the surface of a textured glass-based substrate, according to one or more embodiments described herein;

FIG. 8B graphically depicts the effect of particle size on the root mean square height the surface of a textured glass-based substrate, according to one or more embodiments described herein;

FIG. 9A graphically depicts the effect of particle size on the haze of a textured glass-based substrate, according to one or more embodiments described herein;

FIG. 9B graphically depicts the effect of particle size on the haze of a textured glass-based substrate, according to one or more embodiments described herein;

FIG. 10 depicts a flowchart that includes steps of a method of making a textured article according to one or more embodiments described herein;

FIG. 11A graphically depicts the effect of increased etching on the skewness of height of the surface of a textured glass-based substrate, according to one or more embodiments described herein;

FIG. 11B graphically depicts the effect of increased etching on the mean width of profile elements of the surface of a textured glass-based substrate, according to one or more embodiments described herein;

FIG. 11C graphically depicts the effect of increased etching on the pitch of a textured glass-based substrate, according to one or more embodiments described herein;

FIG. 11D graphically depicts the effect of increased etching on the arithmetical mean height of a textured glass-based substrate, according to one or more embodiments described herein;

FIG. 11E graphically depicts the effect of increased etching on the root mean square height of the surface of a textured glass-based substrate, according to one or more embodiments described herein;

FIG. 12 depicts an exemplary vehicle part incorporating a textured article, according to one or more embodiments described herein;

FIG. 13 depicts an exemplary vehicle interior incorporating a textured article according to one or more embodiments described herein;

FIG. 14A graphically depicts the effect of removal rate on the root mean square height of the surface of a textured glass-based substrate, according to one or more embodiments described herein;

FIG. 14B graphically depicts the effect of removal rate on the root mean square height of the surface of a textured glass-based substrate, according to one or more embodiments described herein;

FIG. 15A graphically depicts the effect of removal rate on the pitch of a textured glass-based substrate, according to one or more embodiments described herein;

FIG. 15B graphically depicts the effect of removal rate on the pitch of a textured glass-based substrate, according to one or more embodiments described herein;

FIG. 16A graphically depicts the effect of particle size on the root mean square height of the surface of a textured glass-based substrate, according to one or more embodiments described herein;

FIG. 16B graphically depicts the effect of particle size on the root mean square height of the surface of a textured glass-based substrate, according to one or more embodiments described herein;

FIG. 17A graphically depicts the effect of removal rate on the arithmetic mean peak curvature of the surface of a textured glass-based substrate, according to one or more embodiments described herein;

FIG. 17B graphically depicts the effect of removal rate on the arithmetic mean peak curvature of the surface of a textured glass-based substrate, according to one or more embodiments described herein; and

FIG. 18 schematically depicts a cross-sectional view of a cold-formed glass sheet according to one or more embodiments described herein.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. Whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

Unless otherwise specified, all compositions of the glasses described herein are expressed in terms of mole percent (mol %), and the constituents are provided on an oxide basis. Unless otherwise specified, all temperatures are expressed in terms of degrees Celsius (C). All ranges disclosed in this specification include any and all ranges and subranges encompassed by the broadly disclosed ranges whether or not explicitly stated before or after a range is disclosed

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. As utilized herein, when the term “about” is used to modify a value, the exact value is also disclosed.

Reference will now be made in detail to textured articles according to various embodiments. In particular, the textured articles are suitable for use as covers and/or housings in portable electronic devices or for use in other non-display applications, such as vehicle interiors or exteriors. The textured articles may have both a roughness Rₐ of greater than about 400 nm and an average pitch, wherein a ratio of roughness Rₐ to average pitch is from about 0.01 to about 0.04. It is believed that the combination of relatively high roughness Rₐ and average pitch, where a ratio of roughness Rₐ to average pitch is from about 0.01 to about 0.04, may improve the tactile feel of the textured article when compared to textured articles with a roughness Rₐ of less than 400 nm and/or a ratio of roughness Rₐ to average pitch that is not from about 0.01 to about 0.04. The textured articles may also have an opacity of greater than about 70%. It is believed that a relatively high opacity may be desired when using the textured articles in non-display applications. The textured articles may include a glass-based substrate. The glass based substrate may be colored, for example, the glass-based substrate may be white or black. Alternatively, the glass-based substrate may be colorless or substantially colorless and the textured article may include a colored film.

The embodiments described herein may be formed by a process that includes abrasion of a glass-based substrate (sometimes sandblasting) followed by etching. As described herein, it is possible to provide particular combinations of surface roughness Rₐ and haze using particular sandblasting media size, pressure or both. In particular larger sandblasting media may promote larger surface features. Additionally, a higher etching target may promote larger surface features. Without being bound by theory, it is believed that larger surface features may improve the tactile feel of a textured article and may increase the haze of a textured article.

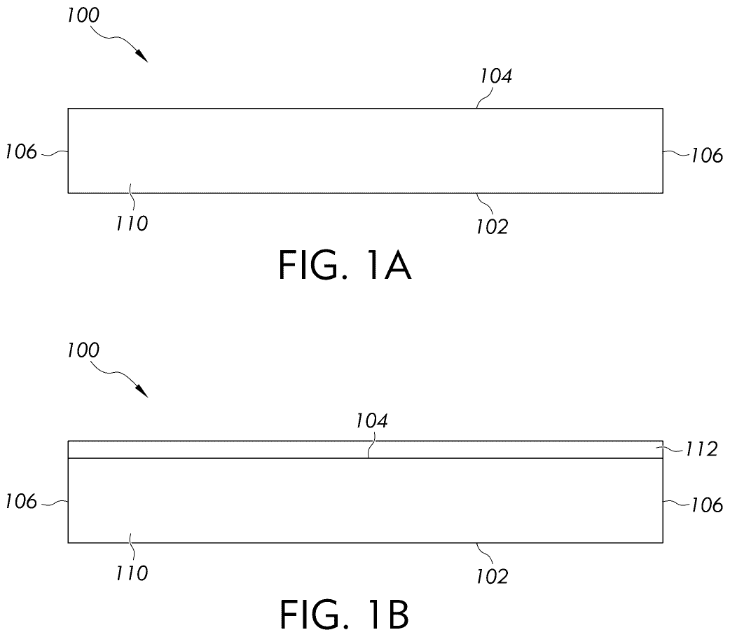

As is depicted in FIG. 1A, a textured article 100 may comprise a glass-based substrate 110, a first major surface 102, and a second major surface 104. The textured article 100 may further include edges 106. In one or more embodiments, the first major surface 102 may be opposite the second major surface 104, and each may be substantially planar. In one or more embodiments one or both of the first major surface 102 and the second major surface 104 may not be substantially planar. A thickness of the textured article 100 may be measured between the first major surface 102 and the second major surface 104. In the embodiments described herein, at least a portion of one or both of the first major surface 102 or the second major surface 104 is textured, as is described in detail herein. The portion of the surface that is textured may have a plurality of surface features, wherein the plurality of surface features comprises protrusions and recesses in the surface. In additional embodiments, the edges 106 may be textured but, generally, optical performance altered by the texturing is not measured on the edges of a glass sheet, so in many embodiments the edges 106 are not textured. According to embodiments, the entirety of any one or more of the first major surface 102, second major surface 104, or edges 106 are textured (where texturing is not explicitly depicted in FIG. 1 since the texturing features are generally very small). In additional embodiments, only portions of any one or more of the first major surface 102, second major surface 104, or edges 106 are textured.

As shown in FIG. 1B, in one or more embodiments, the textured article 100 may also include a colored film 112. In embodiments, the colored film 112 may be adjacent to the first major surface 102, not shown in FIG. 1B, or adjacent to the second major surface 104 as depicted in FIG. 1B. In embodiments, where only one of the first major surface 102 or the second major surface 104 are textured the colored film may be positioned adjacent to the non-textured major surface. In embodiments, the colored film 112 may be a polymer film that may be screen printed or inkjet printed onto a surface of the glass-based substrate 110. In additional embodiments, the colored film 112 may be a metal film that may be deposited onto a surface of the glass-based substrate using physical vapor deposition (PVD) (e.g., reactive or nonreactive sputtering or laser ablation).

As described above, in one or more embodiments, at least a portion of glass-based substrate 110 is textured. In embodiments, the portion of the glass-based substrate 110 that is textured may have a surface roughness Rₐ of greater than or equal to about 400 nm and an average pitch, wherein a ratio of roughness Rₐ to average pitch is from about 0.01 to about 0.04. As used herein, unless otherwise specified, “surface roughness” refers to Rₐ, the arithmetical mean deviation of a measured profile of the surface. As used herein, “pitch” refers to the horizontal distance between recesses in the surface of the glass-based substrate 110. Without being bound by theory, it is believed that the combination of a roughness Rₐ of greater than or equal to about 400 nm and a ratio of roughness Rₐ to average pitch of from about 0.01 to about 0.04 may be associated with improved tactile feeling of a textured article, when compared to textured articles that do not have this combination of surface properties.

In one or more embodiments, the portion of the glass-based substrate 110 that is textured may have a surface roughness Rₐ that is greater than or equal to about 400 nm. For example, the portion of the glass-based substrate 110 that is textured may have a surface roughness of greater than or equal to about 500 nm, greater than or equal to about 750 nm, greater than or equal to about 1000 nm, greater than or equal to about 1250 nm, greater than or equal to about 1500 nm, greater than or equal to about 1750 nm, or even greater than or equal to about 2000 nm. Without being bound by theory, it is believed that a glass-based substrate with an Rₐ in the range of greater than 400 nm may have increased tactile feel. For example, a glass-based substrate with Rₐ less than 400 nm may undesirably have less pleasing touch feel, or may not have any significant tactile feel at all.

In one or more embodiments, the portion of the glass-based substrate 110 that is textured may have a surface roughness Rₐ of from about 400 nm to about 2000 nm, such as from about 400 nm to about 600 nm, from about 600 nm to about 800 nm, from about 800 nm to about 1000 nm, from about 1000 nm to about 1200 nm, from about 1200 nm to about 1400 nm, from about 1400 nm to about 1600 nm, from about 1600 nm to about 1800 nm, from about 1800 nm to about 2000 nm, or any combination of one or more of these ranges. Unless otherwise specified, Rₐ is measured on a Zygo 9000 with the following settings: Scan size was 870 microns by 870 microns; Objective: 20× Mirau; Image Zoom 0.5×; Camera resolution 0.873 microns; Scan Length: 40 microns. However, many other machines may be used to observe and compute Rₐ, as is understood by those skilled in the art.

As described hereinabove, the glass-based substrate 110 may have an average pitch. According to one or more embodiments, the ratio of roughness Rₐ to average pitch may be from about 0.01 to about 0.04, such as from about 0.01 to about 0.015, from about 0.015 to about 0.02, from about 0.02 to about 0.025, from about 0.025 to about 0.03, from about 0.03 to about 0.035, from about 0.035 to 0.04, or any combination of one or more of these ranges. Without being bound by theory, it is believed that a ratio of roughness Rₐ to average pitch of from about 0.01 to about 0.04 may give a glass-based substrate desirable optical characteristics such as high opacity or haze. For example, a glass-based substrate with ratio of roughness Rₐ to average pitch of less than about 0.01 or greater than 0.04 may have lower opacity and/or lower haze than a glass-based substrate with a ratio of roughness Rₐ to average pitch of from about 0.01 to about 0.04.

In one or more embodiments, the average pitch of the glass-based substrate 110 may be from about 10 microns to about 50 microns, such as from about 10 microns to about 20 microns, from about 20 microns to about 30 microns, from about 30 microns to about 40 microns, from about 40 microns to about 50 microns, or any combination of one or more of these ranges. Without being bound by theory it is believed that a glass-based substrate with an average pitch of less than about 10 microns may not have a desirable tactile feel. It is also believed that a glass-based substrate with an average pitch of greater than about 50 microns may not have the desired optical characteristics, such as for example high opacity or haze.

The embodiments disclosed and claimed herein may have a particular coefficient of friction that may be determined, generally, by methods described herein. In general, a coefficient of friction (μ) is a quantitative measurement of the friction between two surfaces and is a function of the mechanical and chemical properties of the first and second surfaces, including surface roughness, as well as environmental conditions such as, but not limited to, temperature and humidity. Unless described otherwise herein, the coefficient of friction refers to the kinetic coefficient of friction using a 500 g load, on a foam rubber according to ASTM D1984, generally at ambient temperature and (e.g., about 25° C.). The coefficient of friction of a surface can generally be measured by applying a known mass to press the surface into another surface and measuring the force required to drag the two surfaces against one another. This can be measured using a coefficient of friction measurement instrument, such as a COF-1000, from ChemInstruments. A coefficient of friction measurement instrument may generally measure the coefficient of friction by moving a test platform at constant speed while a test sled containing the object that is to be tested is held stationary or alternatively by moving the test sled while the test platform is held stationary. Using a known weight of the test sled and the force required to drag the two surfaces against each other the coefficient of friction of the surface to be tested can be determined. The force required to drag the surfaces once they have started moving can be used to determine the kinetic coefficient of friction. The surface of the test platform can be a foam rubber according to ASTM D1984.

The coefficient of friction for samples, as reported in the Examples section hereinafter, utilizes the following test specification to analyze the coefficient of friction. However, other similar methods may be equally appropriate to determine the coefficient of friction. A COF-1000 may be used to test the coefficient of friction of the glass-based substrate. The substrate used may be a Texwipe Alpha® 10 TX® 1012 microfiber cloth available from Texwipe cut into 2 inch by 2 inch squares. The substrate may be attached to a 500 g test sled using double-sided tape. A 4 inch by 4 inch sheet of the glass to be tested may then be attached to the test sled using a clip. Measurements were obtained using the 500 g load at a drag rate of 12 inches per minute. Measurements were taken 5 times and averaged to produce the final coefficient of friction measurement. This procedure was used to test the samples in the Examples described in detail herein below.

In one or more embodiments, the glass-based substrate 110 may have a kinetic coefficient of friction of from about 0.25 to about 0.4, such as from about 0.25 to about 0.275, from about 0.275 to about 0.3, from about 0.3 to about 0.325, from about 0.325 to about 0.35, from about 0.35 to about 0.375, from about 0.375 to about 0.4, or any combination of one or more of these ranges. Without being bound by theory, it is believed that a coefficient of friction of from about 0.25 to about 0.4 may beneficially impact the touch-feel of a glass-based substrate when compared to a glass-based substrate that does not have a coefficient of friction of from about 0.25 to about 0.4.

In one or more embodiments, the glass-based substrate 110 may have a water contact angle after abrasion using a cheesecloth of from about 109° to about 114°. For example, the glass-based substrate may have a water contact angle after abrasion using a cheesecloth of from about 109° to about 110°, from about 110° to about 111°, from about 111° to about 112°, from about 112° to about 113°, from about 113° to about 114°, or any combination of one or more of these ranges.

As used herein, water contact angle is determined following abrasion by a cheesecloth. Abrasion may be performed using an abrading machine, such as, for example, a Taber 5750 Linear Abraser. An abrading machine may rub a surface with an abrading material, such as, for example, a cheesecloth, with a constant motion to simulate long-term wear of the surface. For example, as described herein, the glass-based substrate may be abraded using a Taber 5750 Linear Abraser at a speed of 60 strokes per minute, with a 15 mm stroke length. Four layers of SDL Atlas TIC crockmeter squares may be used as the abrading material. The abrading material may be attached to a 20 mm abrading head. Any excess cloth may be removed to create a smooth surface. The abrading material may be pressed into the surface to be abraded using a weight of 750 g including the abrasion head. The sample to be abraded may be placed below the abrasion head and 100,000 strokes may be run before the abrading material may need to be replaced. Testing may be continued in 100,000 stroke increments until 400,000 strokes are completed. The glass-based substrate may then be removed and the water contact angle of the glass-based substrate may be measured. This procedure was used to test the samples in the Examples described in detail herein below.

The glass-based substrate 110 may have particular desired optical characteristics. In one or more embodiments, the glass-based substrate 110 may be transparent. As used herein the term “transparent” refers to an object that allows all or substantially all light to pass through. In one or more embodiments the glass-based substrate 110 (or colored film 112) may also be colored transparent, opaque, colored opaque, translucent, or colored translucent. As used herein “opaque” and “translucent” can mean as follows: opacity is the measure of impenetrability to visible light. An opaque object is neither transparent (allowing all light to pass through) nor translucent (allowing some light to pass through). When light strikes an interface between two substances, in general some may be reflected, some absorbed, some scattered, and the rest transmitted. An opaque substance transmits very little light, and therefore reflects, scatters, or absorbs most of it. Opacity depends on the frequency of the light being considered. For instance, some kinds of glass, while transparent in the visual range, are largely opaque to ultraviolet light. Further, the colored transparent, colored opaque, and colored translucent can be anyone of a variety of colors including, for example, black, white, green, yellow, pink, red, blue, orange, purple, brown etc. In one or more embodiments, the glass-based substrate 110 may be white, black, or colorless. In one or more embodiments, the glass-based substrate may be colored with color ink.

In one or more embodiments, the glass-based substrate may be white in color. As described herein, a glass-based substrate that is a particular color is generally perceivable to the naked eye as that color, but may deviate slightly from that color. For example, a white substrate may not be absolute white, and so forth. An exemplary white glass-based substrate may have a composition as shown in Table 1 and described in detail below. In such embodiments, the glass-based substrate may have transmittance color coordinates in the (L*, a*, b*) colorimetry system at normal incidence under an International Commission on Illumination illuminant of L* about 25 to about 32, a* about −0.5 to about 0, and b* about −1.5 to about 0. In some embodiments the L* value of the glass-based substrate may be from about 25 to about 32, such as from about 25.5 to about 31.5, from about 26 to about 31, from about 26.5 to about 30.5, from about 27 to about 30, from about 27.5 to about 29.5, or from about 28 to about 29, and all ranges and sub-ranges between the foregoing values. In some embodiments, the a* value of the glass-based substrate may be from about −0.5 to about 0, such as from about −0.45 to about −0.05, or from about −0.4 to about −0.1, from about −0.35 to about −0.15, or from about −0.3 to about −0.2, and all ranges and sub-ranges between the foregoing values. In some embodiments, the b* value of the glass-based substrate may be from about −1.5 to about 0, such as from about −1.4 to about −0.1, from about −1.3 to about −0.2, from about −1.2 to about −0.3, from about −1.1 to about −0.4, from about −1.0 to about −0.5, from about −0.9 to about −0.6, or from about −0.8 to about −0.7, and all ranges and sub-ranges between the foregoing values. As utilized herein, the color coordinates may be measured using an X-rite Color i7-860 benchtop spectrophotometer in accordance with ASTM procedure E429, however many other methods of measuring color coordinates may be able to be used as would be understood by those skilled in the art.

In one or more embodiments, the glass-based substrate may be black. An exemplary black glass-based substrate may have a composition as shown in Table 2 and described in detail below. In such embodiments, the glass-based substrate 110 may have transmittance color coordinates in the (L*, a*, b*) colorimetry system at normal incidence under an International Commission on Illumination illuminant of L* about 90 to about 98, a* about −0.75 to about 0, and b* about −2 to about 0. In some embodiments, the L* value of the glass-based substrate may be from about 90 to about 98, such as from about 91 to about 97, from about 92 to about 96, from about 93 to about 95, or about 94, and all ranges and sub-ranges between the foregoing values. In some embodiments, the a* value of the glass-based substrate may be from about −0.75 to about 0, such as from about −0.7 to about −0.05, from about −0.65 to about −0.1, from about −0.6 to about −0.15, from about −0.55 to about −0.2, from about −0.5 to about −0.25, from about −0.45 to about −0.3, or from about −0.4 to about −0.35, and all ranges and sub-ranges between the foregoing values. In some embodiments, the b* value of the glass-based substrate may be from about −2 to about 0, such as from about −1.75 to about −0.25, from about −1.5 to about −0.5, from about −1.25 to about −0.75, and all ranges and sub-ranges between the foregoing values.

In one or more embodiments, at least a portion of the textured article 100 may have an opacity greater than about 70%, such as greater than about 75%, greater than about 80%, greater than about 90%, greater than about 95%, or even greater than about 99%. As utilized herein, the opacity of the textured article 100 may be measured using an X-rite Color i7-860 benchtop spectrophotometer under similar conditions to ISO method 2471, however many other methods of measuring opacity may be able to be used as would be understood by those skilled in the art.

In one or more embodiments, the haze of the portion of the glass-based substrate 110 that is textured is relatively high and may provide desirable optical properties and a pleasing aesthetic appearance. “Haze” (also referred to as “transmission haze”) is a surface light scatter characteristic and refers to the percentage of light scattered outside an angular cone of 4.0° in accordance with ASTM procedure D1003. For an optically smooth surface, transmission haze is generally close to zero. Low haze can be desirable for applications requiring high display contrast, while high haze can be useful for optical designs having scattering, such as edge illumination, or for aesthetic reasons, such as reducing the “black hole” appearance of the display in the off state. The general preference for low versus high haze (and the acceptance of performance trade-offs) can be motivated by customer or end-user preferences, and their final application and use mode. In one or more embodiments, the haze of the portion of the glass-based substrate 110 that is textured is at least about 40%, such as at least about 45%, at least about 50%, at least about 55%, at least about 60%, at least about 65%, at least about 70%, at least about 75%, at least about 80%, at least about 85%, at least about 90%, or even at least about 95%.

The glass-based substrates 110 utilized to form the textured articles 100 may have any suitable composition. In some embodiments, the glass-based substrate 110 may include a glass ceramic material. In some embodiments, the glass-based substrate may not include a glass ceramic material. In further embodiments, the glass-based substrate 110 may include an alkali aluminosilicate glass. In still more embodiments, the glass-based substrate 110 may include an alkaline earth aluminosilicate glass.

As described above, in one or more embodiments, the glass-based substrate 110 may be white. An exemplary white glass-based substrate composition is described in U.S. Pat. No. 9,809,488, titled “High Strength Glass-Ceramics Having Petalite and Lithium Silicate Structures,” published Nov. 7, 2017, the contents of which are incorporated herein by reference in their entirety. An exemplary white glass-based substrate composition is shown in Table 1.

TABLE 1

| | Amount |
|---|---|
| Component | (wt. %) |
| SiO₂ | 55.0-80.0 |
| Al₂O₃ | 2.0-20.0 |
| LiO₂ | 5.0-20.0 |
| B₂O₃ | 0.0-10.0 |
| Na₂O | 0.0-5.0 |
| ZnO | 0.0-10.0 |
| P₂O₅ | 0.5-6.0 |
| ZrO₂ | 0.2-15.0 |

According to the exemplary white glass-based substrate composition, the glass-based substrate composition may comprise from about 55 wt. % to about 80 wt. % SiO₂. For example, the glass-based substrate composition may comprise SiO₂ from about 55 wt. % to about 60 wt. %, from about 60 wt. % to about 65 wt. %, from about 65 wt. % to about 70 wt. %, from about 70 wt. % to about 75 wt. %, from about 75 wt. % to about 80 wt. %, or any combination of one or more of these ranges.

According to the exemplary white glass-based substrate composition, the glass-based substrate composition may comprise from about 2 wt. % to about 20 wt. % Al₂O₃. For example, the glass-based substrate composition may comprise Al₂O₃ from about 2 wt. % to about 4 wt. %, from about 4 wt. % to about 6 wt. %, from about 6 wt. % to about 8 wt. %, from about 8 wt. % to about 10 wt. %, from about 10 wt. % to about 12 wt. %, from about 12 wt. % to about 14 wt. %, from about 14 wt. % to about 16 wt. %, from about 16 wt. % to about 18 wt. %, from about 18 wt. % to about 20 wt. %, or any combination of one or more of these ranges.

According to the exemplary white glass-based substrate composition, the glass-based substrate composition may comprise from about 5 wt. % to about 20 wt. % Li₂O, such as from about 5 wt. % to about 6 wt. %, from about 6 wt. % to about 8 wt. %, from about 8 wt. % to about 10 wt. %, from about 10 wt. % to about 12 wt. %, from about 12 wt. % to about 14 wt. %, from about 14 wt. % to about 16 wt. %, from about 16 wt. % to about 18 wt. %, from about 18 wt. % to about 20 wt. %, or any combination of one or more of these ranges.

According to the exemplary white glass-based substrate composition, the glass-based substrate composition may comprise from about 0.0 wt. % to about 10.0 wt. % B₂O₃, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, from about 5.0 wt. % to about 6.0 wt. %, from about 6.0 wt. % to about 7.0 wt. %, from about 7.0 wt. % to about 8.0 wt. %, from about 8.0 wt. % to about 9.0 wt. %, from about 9.0 wt. % to about 10.0 wt. %, or any combination of one or more of these ranges.

According to the exemplary white glass-based substrate composition, the glass-based substrate composition may comprise from about 0.0 wt. % to about 5.0 wt. % Na₂O, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, or any combination of one or more of these ranges.

According to the exemplary white glass-based substrate composition, the glass-based substrate composition may comprise from about 0.0 wt. % to about 10.0 wt. % ZnO, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, from about 5.0 wt. % to about 6.0 wt. %, from about 6.0 wt. % to about 7.0 wt. %, from about 7.0 wt. % to about 8.0 wt. %, from about 8.0 wt. % to about 9.0 wt. %, from about 9.0 wt. % to about 10.0 wt. %, or any combination of one or more of these ranges.

According to the exemplary white glass-based substrate composition, the glass-based substrate composition may comprise from about 0.5 wt. % to about 6.0 wt. % P₂O₅, such as from about 0.5 wt. % to about 1 wt. %, from about 1 wt. % to about 1.5 wt. %, from about 1.5 wt. % to about 2 wt. %, from about 2 wt. % to about 2.5 wt. %, from about 2.5 wt. % to about 3 wt. %, from about 3 wt. % to about 3.5 wt. %, from about 3.5 to about 4 wt. %, from about 4 wt. % to about 4.5 wt. %, from about 4.5 wt. % to about 5 wt. %, from about 5 wt. % to about 5.5 wt. %, from about 5.5 wt. % to about 6 wt. %, or any combination of one or more of these ranges.

According to the exemplary white glass-based substrate composition, the glass-based substrate composition may comprise from about 0.2 wt. % to about 15 wt. % ZrO₂, such as from about 0.2 wt. % to about 0.5 wt. %, from about 0.5 wt. % to about 1 wt. %, from about 1 wt. % to about 2 wt. %, from about 2 wt. % to 4 wt. %, from about 4 wt. % to about 6 wt. %, from about 6 wt. % to about 8 wt. %, from about 8 wt. % to about 10 wt. %, from about 10 wt. % to about 12 wt. %, from about 12 wt. % to about 14 wt. %, from about 14 wt. % to 15 wt. %, or any combination of one or more of these ranges.

As described hereinabove, the glass-based substrate 110 may be black. An exemplary black glass-based substrate composition is described in U.S. Pat. No. 10,723,649, titled “Black Lithium Silicate Glass Ceramics,” published Jul. 28, 2020, the contents of which are incorporated herein by reference in their entirety. An exemplary black glass-based substrate composition is shown in Table 2.

TABLE 2

| | Amount |
|---|---|
| Component | (wt. %) |
| SiO₂ | 55.0-75.0 |
| Al₂O₃ | 2.0-20.0 |
| B₂O₃ | 0.0-5.0 |
| Li₂O | 5.0-15.0 |
| Na₂O | 0.0-5.0 |
| K₂O | 0.0-4.0 |
| MgO | 0.0-8.0 |
| ZnO | 0.0-10.0 |
| TiO₂ | 0.5-5.0 |
| P₂O₅ | 1.0-6.0 |
| ZrO₂ | 2.0-10.0 |
| CeO₂ | 0.0-0.4 |
| SnO + SnO₂ | 0.05-5.0 |
| FeO + Fe₂O₃ | 0.1-5.0 |
| NiO | 0.1-5.0 |
| Co₃O₄ | 0.1-5.0 |
| MnO + | 0.0-4.0 |
| MnO₂ + Mn₂O₃ | |
| Cr₂O₃ | 0.0-2.0 |
| CuO | 0.0-2.0 |
| V₂O₅ | 0.0-2.0 |

According to the exemplary black glass-based substrate composition, the glass-based substrate composition may comprise from about 55 wt. % to about 75 wt. % SiO₂. For example, the glass-based substrate composition may comprise SiO₂ from about 55 wt. % to about 60 wt. %, from about 60 wt. % to about 65 wt. %, from about 65 wt. % to about 70 wt. %, from about 70 wt. % to about 75 wt. %, or any combination of one or more of these ranges.

According to the exemplary black glass-based substrate composition, the glass-based substrate composition may comprise from about 2 wt. % to about 20 wt. % Al₂O₃. For example, the glass-based substrate composition may comprise Al₂O₃ from about 2 wt. % to about 4 wt. %, from about 4 wt. % to about 6 wt. %, from about 6 wt. % to about 8 wt. %, from about 8 wt. % to about 10 wt. %, from about 10 wt. % to about 12 wt. %, from about 12 wt. % to about 14 wt. %, from about 14 wt. % to about 16 wt. %, from about 16 wt. % to about 18 wt. %, from about 18 wt. % to about 20 wt. %, or any combination of one or more of these ranges.

According to the exemplary black glass-based substrate composition, the glass-based substrate composition may comprise from about 0.0 wt. % to about 5.0 wt. % B₂O₃, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, or any combination of one or more of these ranges.

According to the exemplary black glass-based substrate composition, the glass-based substrate composition may comprise from about 5 wt. % to about 15 wt. % Li₂O, such as from about 5 wt. % to about 7 wt. %, from about 7 wt. % to about 9 wt. %, from about 9 wt. % to about 11 wt. %, from about 11 wt. % to about 13 wt. %, from about 13 wt. % to about 15 wt. %, or any combination of one or more of these ranges.

According to the exemplary black glass-based substrate composition, the glass-based substrate composition may comprise from about 0.0 wt. % to about 5.0 wt. % Na₂O, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, or any combination of one or more of these ranges.

According to the exemplary black glass-based substrate composition, the glass-based substrate composition may comprise from about 0.0 wt. % to about 4.0 wt. % K₂O, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, or any combination of one or more of these ranges.

According to the exemplary black glass-based substrate composition, the glass-based substrate composition may comprise from about 0.0 wt. % to about 8.0 wt. % MgO, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, from about 5.0 wt. % to about 6.0 wt. %, from about 6.0 wt. % to about 7.0 wt. %, from about 7.0 wt. % to about 8.0 wt. %, or any combination of one or more of these ranges.

According to the exemplary black glass-based substrate composition, the glass-based substrate composition may comprise from about 0.0 wt. % to about 5.0 wt. % TiO₂, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, or any combination of one or more of these ranges.

According to the exemplary black glass-based substrate composition, the glass-based substrate composition may comprise from about 1 wt. % to about 6.0 wt. % P₂O₅, such as from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, from about 5.0 wt. % to about 6.0 wt. %, or any combination of one or more of these ranges.

According to the exemplary black glass-based substrate composition, the glass-based substrate composition may comprise from about 2 wt. % to about 10 wt. % ZrO₂, such as from about 2.0 wt. % to about 3.0 wt. %, from about 3.0 wt. % to about 4.0 wt. %, from about 4.0 wt. % to about 5.0 wt. %, from about 5.0 wt. % to about 6.0 wt. %, from about 6.0 wt. % to about 7.0 wt. %, from about 7.0 wt. % to about 8.0 wt. %, from about 8.0 wt. % to about 9.0 wt. %, from about 9.0 wt. % to about 10.0 wt. %, or any combination of one or more of these ranges.

According to the exemplary black glass-based substrate composition, the glass-based substrate composition may comprise from about 0.0 wt. % to about 0.4 wt. % CeO₂, such as from about 0.0 wt. % to about 0.1 wt. %, from about 0.1 wt. % to about 0.2 wt. %, from about 0.2 wt. % to about 0.3 wt. %, from about 0.3 wt. % to about 0.4 wt. %, or any combination of one or more of these ranges.

According to the exemplary black glass-based substrate composition, the glass-based substrate composition may comprise from about 0.0 wt. % to about 0.5 wt. % SnO+SnO₂, such as from about 0.0 wt. % to about 0.1 wt. %, from about 0.1 wt. % to about 0.2 wt. %, from about 0.2 wt. % to about 0.3 wt. %, from about 0.3 wt. % to about 0.4 wt. %, from about 0.4 wt. % to about 0.05 wt. %, or any combination of one or more of these ranges.

According to the exemplary black glass-based substrate composition, the glass-based substrate composition may comprise from about 0.0 wt. % to about 5.0 wt. % FeO+Fe₂O₃, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, or any combination of one or more of these ranges.

According to the exemplary black glass-based substrate composition, the glass-based substrate composition may comprise from about 0.0 wt. % to about 5.0 wt. % NiO, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, or any combination of one or more of these ranges.

According to the exemplary black glass-based substrate composition, the glass-based substrate composition may comprise from about 0.0 wt. % to about 5.0 wt. % Co₃O₄, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, from about 4.0 wt. % to about 5.0 wt. %, or any combination of one or more of these ranges.

According to the exemplary black glass-based substrate composition, the glass-based substrate composition may comprise from about 0.0 wt. % to about 4.0 wt. % MnO+MnO₂+Mn₂O₃, such as from about 0.0 wt. % to about 1.0 wt. %, from about 1.0 wt. % to about 2.0 wt. %, from about 2.0 wt. % to about 3.0 wt. %, from about 3.0 wt. % to about 4.0 wt. %, or any combination of one or more of these ranges.

According to the exemplary black glass-based substrate composition, the glass-based substrate composition may comprise from about 0.0 wt. % to about 2.0 wt. % Cr₂O₃, such as from about 0.0 wt. % to about 0.5 wt. %, from about 0.5 wt. % to about 1.0 wt. %, from about 1.0 wt. % to about 1.5 wt. %, from about 1.5 wt. % to about 2.0 wt. %, or any combination of one or more of these ranges.

According to the exemplary black glass-based substrate composition, the glass-based substrate composition may comprise from about 0.0 wt. % to about 2.0 wt. % CuO, such as from about 0.0 wt. % to about 0.5 wt. %, from about 0.5 wt. % to about 1.0 wt. %, from about 1.0 wt. % to about 1.5 wt. %, from about 1.5 wt. % to about 2.0 wt. %, or any combination of one or more of these ranges.

According to the exemplary black glass-based substrate composition, the glass-based substrate composition may comprise from about 0.0 wt. % to about 2.0 wt. % V₂O₅, such as from about 0.0 wt. % to about 0.5 wt. %, from about 0.5 wt. % to about 1.0 wt. %, from about 1.0 wt. % to about 1.5 wt. %, from about 1.5 wt. % to about 2.0 wt. %, or any combination of one or more of these ranges.

In one or more embodiments, the glass-based substrate 110 may be colorless. An exemplary colorless glass-based substrate composition is described in U.S. Pat. No. 11,279,649, titled “Fracture and Scratch Resistant Glass Articles,” published Mar. 22, 2022, the contents of which are incorporated herein by reference in their entirety. An exemplary colorless glass-based substrate composition is shown in Table 3 and described in detail below.

TABLE 3

| | Amount |
|---|---|
| Component | (mol %) |
| SiO₂ | 60.0-80.0 |
| Al₂O₃ | 10.0-20.0 |
| LiO₂ | 4.0-6.0 |
| Na₂O | 4.5-12.0 |
| ZnO | 0.5-3.0 |
| B₂O₃ | 0.9-7.5 |
| P₂O₅ | 0.0-10.0 |

According to the exemplary colorless glass-based substrate composition, the glass-based substrate composition may comprise SiO₂ from about 60 mol % to about 80 mol %, such as from about 60 mol % to about 62 mol %, from about 62 mol % to about 64 mol %, from about 64 mol % to about 66 mol %, from about 66 mol % to about 68 mol %, from about 68 mol % to about 70 mol %, from about 70 mol % to about 72 mol %, from about 72 mol % to about 74 mol %, from about 74 mol % to about 76 mol %, from about 76 mol % to about 78 mol %, from about 78 mol % to about 80 mol %, or any combination of one or more of these ranges.

According to the exemplary colorless glass-based substrate composition, the glass-based substrate composition may comprise from about 10 mol % to about 20 mol % Al₂O₃, such as from about 10 mol % to about 12 mol %, from about 12 mol % to about 14 mol %, from about 14 mol % to about 16 mol %, from about 16 mol % to about 18 mol %, from about 18 mol % to about 20 mol %, or any combination of one or more of these ranges

According to the exemplary colorless glass-based substrate composition, the glass-based substrate composition may comprise from about 4.0 mol % to about 6.0 mol % Li₂O, such as from about 4.0 mol % to about 4.5 mol %, from about 4.5 mol % to about 5.0 mol %, from about 5.0 mol % to about 5.5 mol %, from about 5.5 mol % to about 6.0 mol %, or any combination of one or more of these ranges.

According to the exemplary colorless glass-based substrate composition, the glass-based substrate composition may comprise B₂O₃ in an amount from about 0.5 mol % to about 7.5 mol %, such as from about 0.5 mol % to about 1 mol %, from about 1 mol % to about 1.5 mol %, from about 1.5 mol % to about 2 mol %, from about 2 mol % to about 2.5 mol %, from about 2.5 mol % to about 3 mol %, from about 3.5 mol % to about 4 mol %, from about 4 mol % to about 4.5 mol %, from about 4.5 mol % to about 5 mol %, from about 5 mol % to about 5.5 mol %, from about 5.5 mol % to about 6 mol %, from about 6 mol % to about 6.5 mol %, from about 6.5 mol % to about 7 mol %, or any combination of one or more of these ranges.

According to the exemplary colorless glass-based substrate composition, the glass-based substrate composition may comprise Na₂O in a range from about 0.5 mol % to about 12 mol %, such as from about 0.5 mol % to about 1 mol %, from about 1 mol % to about 2 mol %, from about 2 mol % to about 3 mol %, from about 3 mol % to about 4 mol %, from about 4 mol % to about 5 mol %, from about 5 mol % to about 6 mol %, from about 6 mol % to about 7 mol %, from about 7 mol % to about 8 mol %, from about 8 mol % to about 9 mol %, from about 9 mol % to about 10 mol %, from about 10 mol % to about 11 mol %, from about 11 mol % to about 12 mol %, or any combination of one or more of these ranges. In some embodiments, the amount of Na₂O in the glass-based substrate composition may be greater than the amount of Li₂O in the glass-based substrate composition.

According to the exemplary colorless glass-based substrate composition, the glass-based substrate composition may comprise ZnO in a range from about 0.05 mol % to about 4.5 mol %, such as from about 0.05 mol % to about 1 mol %, from about 1 mol % to about 2 mol %, from about 2 mol % to about 2.5 mol %, from about 2.5 mol % to about 3 mol %, from about 3 mol % to about 3.5 mol %, from about 3.5 mol % to about 4 mol %, from about 4 mol % to about 4.5 mol %, or any combination of one or more of these ranges.

According to the exemplary colorless glass-based substrate composition, the glass-based substrate composition may comprise P₂O₅ in a range from about 0 mol % to about 10 mol %, such as from about 0 mol % to about 1 mol %, from about 1 mol % to about 2 mol %, from about 2 mol % to about 3 mol %, from about 3 mol % to about 4 mol %, from about 4 mol % to about 5 mol %, from about 5 mol % to about 6 mol %, from about 6 mol % to about 7 mol %, from about 7 mol % to about 8 mol %, from about 8 mol % to about 9 mol %, from about 9 mol % to about 10 mol %, or any combination of one or more of these ranges.

According to the exemplary colorless glass-based substrate composition, the total amount of B₂O₃, P₂O₅, SiO₂ and Al₂O₃ in the glass-based substrate composition may be about 80 mol % or greater. In some embodiments, the total amount of B₂O₃, P₂O₅, SiO₂ and Al₂O₃ may be in a range from about 80 mol % to about 94 mol %, such as from about 80 mol % to about 82 mol %, from about 82 mol % to about 84 mol %, from about 84 mol % to about 86 mol %, from about 86 mol % to about 88 mol %, from about 88 mol % to about 90 mol %, from about 90 mol % to about 92 mol %, from about 92 mol % to about 94 mol %, or any combination of one or more of these ranges.

According to the exemplary colorless glass-based substrate composition, the ratio of Li₂O to the sum or total amount of B₂O₃, P₂O₅, SiO₂ and Al₂O₃(B₂O₃+P₂O₅+SiO₂+Al₂O₃) is less than about 0.074 (e.g., about 0.073 or less, about 0.072 or less, about 0.071 or less, about 0.07 or less). In some embodiments, the ratio of Li₂O to the sum or total amount of B₂O₃, P₂O₅, SiO₂ and Al₂O₃ is in the range from about 0.065 to about 0.073. The exemplary colorless glass-based substrate composition may not include glass-ceramic materials and may be free of nucleating agents.

As described hereinabove, in one or more embodiments, the glass-based substrate 110 may be colorless. A second exemplary colorless glass-based substrate composition is described in U.S. Patent Application No. 63/428,176, titled “Lithium Aluminosilicate Glasses for Chemical Strengthening,” filed Nov. 28, 2022, the contents of which are incorporated herein by reference in their entirety. A second exemplary colorless glass-based substrate composition is shown in Table 4A and described in detail below.

TABLE 4A

| | Amount |
|---|---|
| Component | (mol %) |
| SiO₂ | 60.0-70.0 |
| Al₂O₃ | 5.0-20.0 |
| MgO | 1.0-4.0 |
| LiO₂ | 0.5-10.0 |
| P₂O₅ | 0.45-6.0 |
| Na₂O | 0.0-15.0 |
| B₂O₃ | 0.0-5.0 |
| ZnO | 0.0-1.0 |
| K₂O | 0.0-0.5 |

According to the second exemplary colorless glass-based substrate composition, the glass-based substrate composition may comprise SiO₂ in a range from about 60.0 mol % to about 70.0 mol %, such as from about 60.0 mol % to about 62.0 mol %, from about 62.0 mol % to about 64.0 mol %, from about 64.0 mol % to about 66.0 mol %, from about 66.0 mol % to about 68.0 mol %, from about 68.0 mol % to about 70.0 mol %, or any combination of one or more of these ranges.

According to the second exemplary colorless glass-based substrate composition, the glass-based substrate composition may comprise Al₂O₃ in a range from about 5.0 mol % to about 20.0 mol %, such as from about 5.0 mol % to about 7.0 mol %, from about 7.0 mol % to about 9.0 mol %, from about 9.0 mol % to about 11.0 mol %, from about 11.0 mol % to about 13.0 mol %, from about 13.0 mol % to about 15.0 mol %, from about 15.0 mol % to about 17.0 mol %, from about 17.0 mol % to about 19.0 mol %, from about 19.0 mol % to about 20.0 mol %, or any combination of one or more of these ranges.

According to the second exemplary colorless glass-based substrate composition, the glass-based substrate composition may comprise MgO in a range from about 1.0 mol % to about 4.0 mol %, such as from about 1.0 mol % to about 1.5 mol %, from about 1.5 mol % to about 2.0 mol %, from about 2.0 mol % to about 2.5 mol %, from about 2.5 mol % to about 3.0 mol %, from about 3.0 mol % to about 3.5 mol %, from about 3.5 mol % to about 4.0 mol %, or any combination of one or more of these ranges.

According to the second exemplary colorless glass-based substrate composition, the glass-based substrate composition may comprise Li₂O in a range from about 0.5 mol % to about 10 mol %, such as from about 0.5 mol % to about 1 mol %, from about 1 mol % to about 2 mol %, from about 2 mol % to about 3 mol %, from about 3 mol % to about 4 mol %, from about 4 mol % to about 5 mol %, from about 5 mol % to about 6 mol %, from about 6 mol % to about 7 mol %, from about 7 mol % to about 8 mol %, from about 8 mol % to about 9 mol %, from about 9 mol % to about 10 mol %, or any combination of one or more of these ranges

According to the second exemplary colorless glass-based substrate composition, the glass-based substrate composition may comprise P₂O₅ in a range from about 0.45 mol %, to about 6.0 mol %, such as from about 0.45 mol % to about 0.5 mol %, from about 0.5 mol % to about 1.0 mol %, from about 1.0 mol % to about 1.5 mol %, from about 1.5 mol % to about 2.0 mol %, from about 2.0 mol % to about 2.5 mol %, from about 2.5 mol % to about 3.0 mol %, from about 3.0 mol % to about 3.5 mol %, from about 3.5 mol % to about 4.0 mol %, from about 4.0 mol % to about 4.5 mol %, from about 4.5 mol % to about 5.0 mol %, from about 5.0 mol % to about 5.5 mol %, from about 5.5 mol % to about 6.0 mol %, or any combination of one or more of these ranges.

According to the second exemplary colorless glass-based substrate composition, the glass-based substrate composition may comprise Na₂O in a range from about 0.0 mol % to about 15.0 mol %, such as from about 0.0 mol % to about 1.0 mol %, from about 1.0 mol % to about 2.0 mol %, from about 2.0 mol % to about 3.0 mol %, from about 3.0 mol % to about 4.0 mol %, from about 4.0 mol % to about 5.0 mol %, from about 5.0 mol % to about 6.0 mol %, from about 6.0 mol % to about 7.0 mol %, from about 7.0 mol % to about 8.0 mol %, from about 8.0 mol % to about 9.0 mol %, from about 9.0 mol % to about 10.0 mol %, from about 10.0 mol % to about 11.0 mol %, from about 11.0 mol % to about 12.0 mol %, from about 12.0 mol % to about 13.0 mol %, from about 13.0 mol % to about 14.0 mol %, from about 14.0 mol % to about 15.0 mol %, or any combination of one or more of these ranges.

According to the second exemplary colorless glass-based substrate composition, the glass-based substrate composition may comprise B₂O₃ in a range from about 0.0 mol % to about 5.0 mol %, such as from about 0.0 mol % to about 1.0 mol %, from about 1.0 mol % to about 2.0 mol %, from about 2.0 mol % to about 3.0 mol %, from about 3.0 mol % to about 4.0 mol %, from about 4.0 mol % to about 5.0 mol %, or any combination of one or more of these ranges.

According to the second exemplary colorless glass-based substrate composition, the glass-based substrate composition may comprise ZnO in a range from about 0.0 mol % to about 1.0 mol %, such as from about 0.0 mol % to about 0.2 mol %, from about 0.2 mol % to about 0.4 mol %, from about 0.4 mol % to about 0.6 mol %, from about 0.6 mol % to about 0.8 mol %, from about 0.8 mol % to about 1.0 mol %, or any combination of one or more of these ranges.

According to the second exemplary colorless glass-based substrate composition, the glass-based substrate composition may comprise K₂O in a range from about 0.0 mol % to about 0.5 mol %, such as from about 0.0 mol % to about 0.1 mol %, from about 0.1 mol % to about 0.2 mol %, from about 0.2 mol % to about 0.3 mol %, from about 0.3 mol % to about 0.4 mol %, from about 0.4 mol % to about 0.5 mol %, or any combination of one or more of these ranges.

According to the second exemplary colorless glass-based substrate composition, the glass-based substrate composition, may comprise Alk₂O in an amount less than or equal to about 16.0 mol %. “Alk₂O” as used herein refers to the total sum of alkali metal oxides in a glass composition, in mol %, specifically Li₂O+Na₂O+K₂O+Rb₂O+Cs₂O. In some embodiments the glass-substrate composition may comprise Alk₂O in an amount less than or equal to 15.0 mol %, such as less than or equal to 14.0 mol %, less than or equal to 13.0 mol %, less than or equal to 12.0 mol %, less than or equal to 11.0 mol %, less than or equal to 10.0 mol %, less than or equal to 9.0 mol %, less than or equal to 8.0 mol %, less than or equal to 7.0 mol %, less than or equal to 6.0 mol %, less than or equal to 5.0 mol %, less than or equal to 4.0 mol %, less than or equal to 3.0 mol %, less than or equal to 2.0 mol %, or even less than or equal 1.0 mol %.

According to the second exemplary colorless glass-based substrate composition, the glass-based substrate composition may be substantially free of REₘOₙ. “REₘOₙ” as used herein refers to the total sum of rare earth metal oxides in a glass composition, in mol %, specifically La₂O₃+Y₂O₃+Gd₂O₃+Yb₂O₃+Lu₂O₃+Ce₂O₃+Pr₂O₃+Nd₂O₃+Sm₂O₃+Eu₂O₃+Tb₂O₃+Dy₂O₃+Ho₂O₃+Er₂O₃+Tm₂O₃. In some embodiments, the glass-based composition may contain rare earth metal oxides REₘOₙ in an amount less than or equal to 1.5 mol. %, less than or equal to 1.0 mol. %, or less than or equal to 0.3 mol. %. In some more embodiments, the glass composition may contain REₘOₙ in an amount greater than or equal to 0.0 mol. % and less than or equal to 1.5 mol. %, greater than or equal to 0.0 mol. % and less than or equal to 0.3 mol. %, greater than or equal to 0.0 mol. % and less than or equal to 1.0 mol. %.

According to the second exemplary colorless glass-based substrate composition, the glass-based substrate composition may have a ratio of alkali oxides Alk₂O to Al₂O₃ (Alk₂O/Al₂O₃) in a range from greater than or equal to 0.85 mol % to less than or equal to 1.2 mol %, such as from greater than or equal to 0.85 mol % to less than or equal to 0.90 mol %, from greater than or equal to 0.90 mol % to less than or equal to 0.95 mol %, from greater than or equal to 0.95 mol % to less than or equal to 1.00 mol %, from greater than or equal to 1.00 mol % to less than or equal to 1.05 mol %, from greater than or equal to 1.05 mol % to less than or equal to 1.10 mol %, from greater than or equal to 1.10 mol % to less than or equal to 1.15 mol %, from greater than or equal to 1.15 mol % to less than or equal to 1.20 mol %, or any combination of one or more of these ranges.

As described hereinabove, in one or more embodiments, the glass-based substrate 110 may be colorless. A third exemplary colorless glass-based substrate composition is described in U.S. Pat. No. 8,951,927, titled “Zircon Compatible, Ion Exchangeable Glass with High Damage Resistance,” published Feb. 10, 2015, the contents of which are incorporated herein by reference in their entirety. An exemplary colorless glass-based substrate composition is shown in table 4B and described in detail below. An exemplary composition of the third colorless glass-based substrate can be found in table 11 below. Further, examples of such colorless glass-based substrates include, but are not limited to Gorilla Glass III® (commercially available from Corning, Inc.).

TABLE 4B

| | Amount |
|---|---|
| Component | (mol %) |
| SiO₂ | 66.0-74.0 |
| Al₂O₃ | 9.0-22.0 |
| R₂O | >10.0 |
| B₂O₃ | 2.5-4.5 |

According to the third exemplary colorless glass-based substrate composition, the glass-based substrate composition may comprise SiO₂ in a range from about 66.0 mol % to about 74.0 mol %, such as from about 66.0 mol % to about 68.0 mol %, from about 68.0 mol % to about 70.0 mol %, from about 70.0 mol % to about 72.0 mol %, from about 72.0 mol % to about 74.0 mol %, or any combination of one or more of these ranges.

According to the third exemplary colorless glass-based substrate composition, the glass-based substrate composition may comprise Al₂O₃ in a range from about 9.0 mol % to about 22.0 mol %, such as from about 9.0 mol % to about 10 mol %, from about 10 mol % to about 12 mol %, from about 12 mol % to about 14 mol %, from about 14 mol % to about 16 mol %, from about 16 mol % to about 18 mol %, from about 18 mol % to about 20 mol %, from about 20 mol % to about 22 mol %, or any combination of one or more of these ranges.

According to the third exemplary colorless glass-based substrate composition, the glass-based substrate composition may comprise at least about 10 mol % of at least one alkali metal oxide R₂O, wherein R₂O includes Na₂O and, optionally, other alkali metal oxides (e.g., Li₂O, K₂O, Ce₂O, Rb₂O). In one or more embodiments R₂O comprises from about 9 mol % to about 20 mol % of Na₂O, such as from about 9 mol % to about 10 mol %, from about 10 mol % to about 12 mol %, from about 12 mol % to about 14 mol %, from about 14 mol % to about 16 mol %, from about 16 mol % to about 18 mol %, from about 18 mol % to about 20 mol %, or any combination of one or more of these ranges. In one or more embodiments, the amount of R₂O (mol %) may be greater than the amount of Al₂O₃ in the glass-based substrate composition.

According to the third exemplary colorless glass-based substrate composition, the glass-based substrate composition may comprise B₂O₃ in a range from about 2.5 mol % to about 4.5 mol %, such as from about 2.5 mol % to about 3.0 mol %, from about 3.0 mol % to about 3.5 mol %, from about 3.5 mol % to about 4.0 mol %, from about 4.0 mol % to about 4.5 mol %, or any combination of one or more of these ranges. In one or more embodiments, the amount of B₂O₃ mol %-(R₂O mol %-Al₂O₃ mol %)≥2.25 mol %.

In one or more embodiments, the textured article may comprise one or more curved surfaces. The textured article may be formed with curved surfaces by a variety of techniques such as, without limitation, cold-forming or molding.

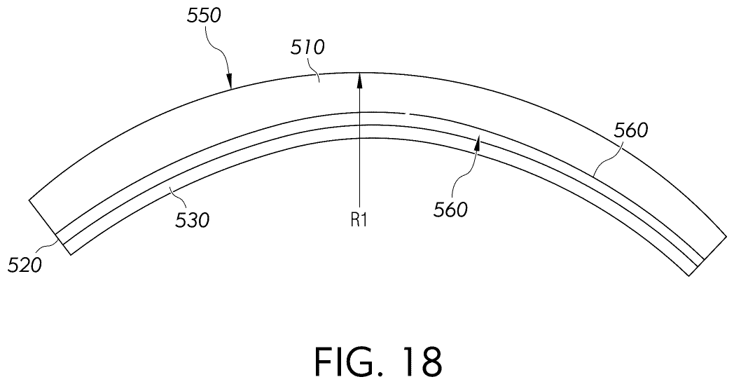

In one or more embodiments, the glass-based substrate may be a cold-formed glass sheet. As shown in FIG. 18, cold-formed glass sheet 510 is shaped to a curved shape having at least one radius of curvature, shown as R1. In various embodiments, cold-formed glass sheet 510 may be shaped to the curved shape via any suitable process, comprising cold-forming and hot-forming.

In specific embodiments, cold-formed glass sheet 510 is shaped to the curved shape shown in FIG. 18, either alone, or following attachment to the frame 530 via the polymer layer 520, via a cold-forming process. As used herein, the terms “cold-bent,” “cold-bending,” “cold-formed” or “cold-forming” refers to curving the glass decorated glass at a cold-form temperature which is less than the softening point of the glass (as described herein). A feature of a cold-formed glass layer is an asymmetric surface compressive between the first major surface 550 and the second major surface 560. In some embodiments, prior to the cold-forming process or being cold-formed, the respective compressive stresses in the first major surface 550 and the second major surface 560 are substantially equal.

In some such embodiments in which cold-formed glass sheet 510 is unstrengthened, the first major surface 550 and the second major surface 560 exhibit no appreciable compressive stress, prior to cold-forming. In some such embodiments in which cold-formed glass sheet 510 is strengthened (as described herein), the first major surface 550 and the second major surface 560 exhibit substantially equal compressive stress with respect to one another, prior to cold-forming. In one or more embodiments, after cold-forming the compressive stress on the second major surface 560 (e.g., the concave surface following bending) increases (i.e., the compressive stress on the second major surface 560 is greater after cold-forming than before cold-forming).

Without being bound by theory, the cold-forming process increases the compressive stress of the glass article being shaped to compensate for tensile stresses imparted during bending and/or forming operations. In one or more embodiments, the cold-forming process causes the second major surface 560 to experience compressive stresses, while the first major surface 550 (e.g., the convex surface following bending) experiences tensile stresses. The tensile stress experienced by the first major surface 2050 following bending results in a net decrease in surface compressive stress, such that the compressive stress in the first major surface 550 of a strengthened glass sheet following bending is less than the compressive stress in the first major surface 550 when the glass sheet is flat.

Further, when a strengthened glass sheet is utilized for cold-formed glass sheet 510, the first major surface and the second major surface (550, 560) are already under compressive stress, and thus first major surface 550 can experience greater tensile stress during bending without risking fracture. This allows for the strengthened embodiments of cold-formed glass sheet 510 to conform to more tightly curved surfaces (e.g., shaped to have smaller R1 values).

In various embodiments, the thickness of cold-formed glass sheet 510 is tailored to allow cold-formed glass sheet 510 to be more flexible to achieve the desired radius of curvature. Moreover, a thinner cold-formed glass sheet 510 may deform more readily, which could potentially compensate for shape mismatches and gaps that may be created by the shape of a support or frame (as discussed below). In one or more embodiments, a thin and strengthened cold-formed glass sheet 510 exhibits greater flexibility especially during cold-forming. The greater flexibility of the glass articles discussed herein may allow for consistent bend formation without heating.

In various embodiments, cold-formed glass sheet 510 may have a compound curve comprising a major radius and a cross curvature. A complexly curved cold-formed glass sheet 510 may have a distinct radius of curvature in two independent directions. According to one or more embodiments, the complexly curved cold-formed glass sheet 510 may thus be characterized as having “cross curvature,” where the cold-formed glass sheet 510 is curved along an axis (i.e., a first axis) that is parallel to a given dimension and also curved along an axis (i.e., a second axis) that is perpendicular to the same dimension. The curvature of the cold-formed glass sheet 510 can be even more complex when a significant minimum radius is combined with a significant cross curvature, and/or depth of bend.

In one or more embodiments, the textured article may be a vehicle part or a portion of a vehicle part. Vehicles may include, for example, automobiles, trains, aircraft, sea craft, etc. In one or more embodiments, the vehicle part may be chosen from a knob for a gear shifter, a dial, an interior panel, a steering wheel, a door trim, a button, a key fob, a pillar cover, and a door handle. In one or more embodiments, a vehicle may comprise a vehicle part and the textured article may be a vehicle part or a portion of a vehicle part.

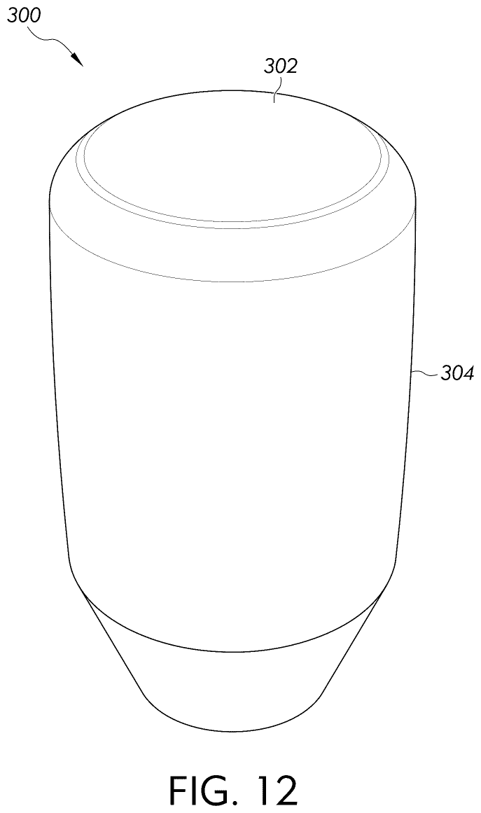

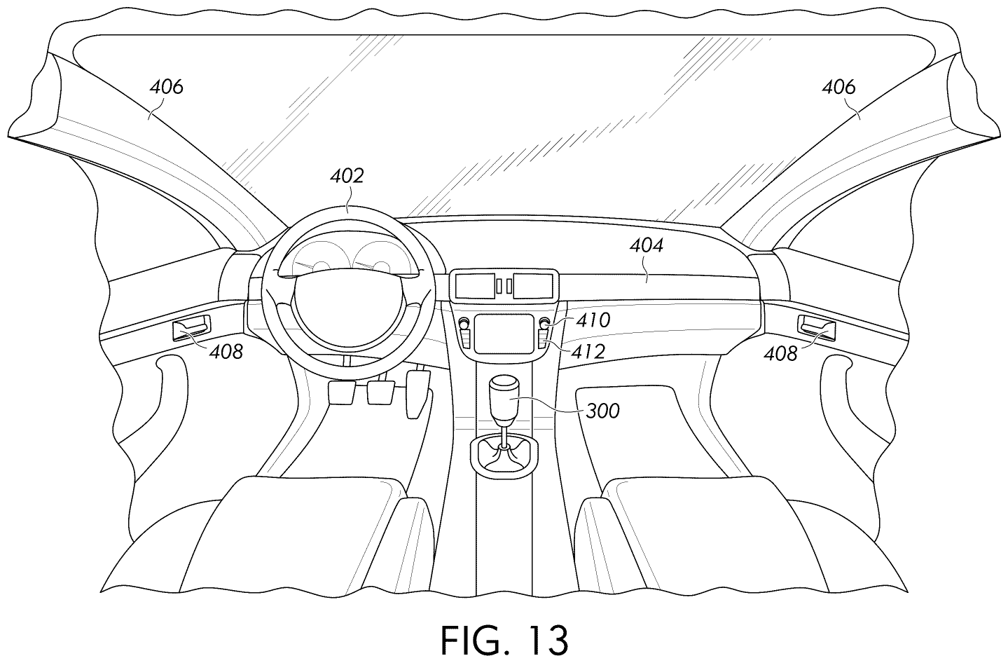

Exemplary articles that may incorporate the textured articles disclosed herein are shown in FIGS. 12 and 13. Specifically, FIG. 12 depicts a knob 300 for a gear shifter that includes a first surface 302 forming a flat top and a second surface 304 that forms the body of the knob. In one or more embodiments, one or more of the first surface 302 and the second surface 304 may comprise a glass bases substrate and one or both of first surface 302 and the second surface 304 may comprise the textured articles disclosed herein. FIG. 13 depicts a car interior 400 comprising a number of vehicle parts that may include the textured articles described herein, such as a steering wheel 402, interior panel 404, pillar cover 406, door handle 408, knob 300, dial 410, and button 412.

The textured articles 100 described herein may be produced utilizing a variety of processes, such as abrasion combined with etching techniques. The textured article 100 may be produced by techniques that combine sandblasting and etching processes. In some embodiments, the etching is performed utilizing a basic etchant. For example, a hydroxide such as KOH or NaOH may be utilized. In other embodiments, the etching may be performed using an acidic etchant, such as hydrofluoric acid or citric acid. However, the use of hydrofluoric acid presents significant safety and environmental challenges. Alternative techniques, such as those that do not employ HF acid etching have previously exhibited long manufacturing times (slow manufacturing throughput) and/or inferior surface, optical, and mechanical properties.

The processes described herein that utilize basic etchants are capable of producing textured articles 100 with surface, optical, and mechanical properties equivalent to those produced by an HF acid etching process while also exhibiting a desirable manufacturing throughput capability. The processes may be relatively fast and produces a substantially uniform surface. In addition, the processes described herein may not utilize HF acid, and thereby avoid the safety and environmental risks associated with HF acid.

While it should be understood that many various processes may be utilized to make the textured articles 100 described herein, embodiments utilizing abrasion and etching are described in detail herein.

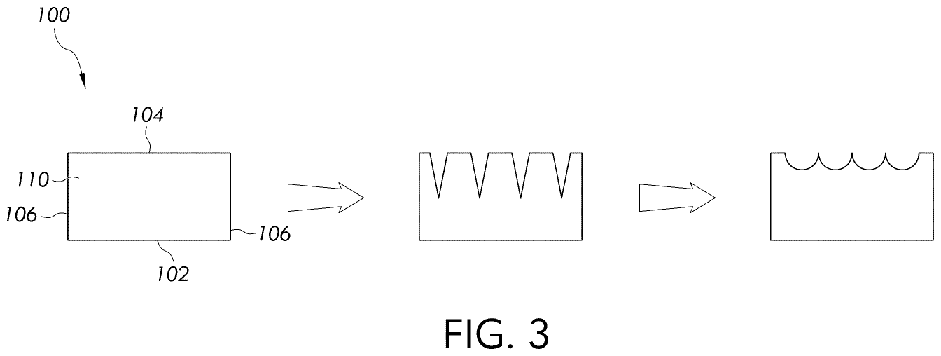

According to one or more embodiments described herein, a method of making a textured article may generally include abrading at least a portion of a first major surface, a second major surface, or both, of a glass-based substrate to form an abraded surface by propelling abrasive particles against the surface and etching the abraded surface with an etchant to form a textured glass-based substrate. This process is generally shown in FIG. 3, where the second major surface 104 is first abraded to form at least a plurality of surface features and then etched to further control the shape of the surface features on the second major surface 104.

In embodiments, the abrasion process may be a particulate blasting process, commonly referred to as media blasting or sand blasting, in which abrasive particles are propelled against the surface of the glass-based substrate by a pressurized fluid medium. The abrasion process may include one or more treatments of the surface. In embodiments, the abrasion process may be repeated one or more times to achieve the desired effect.

The abrasion process may employ any appropriate abrasive particles. In embodiments, the abrasive particles may include any one of sand, Al₂O₃, SiC, or SiO₂, and combinations thereof. The abrasive particles may have a particle size selected to produce the desired abrading effect. In one or more embodiments the abrasive medium may have an average diameter of from about 7 microns to about 70 microns, such as from about 7 microns to about 10 microns, from about 10 microns to about 15 microns, from about 15 microns to about 20 microns, from about 20 microns to about 25 microns, from about 25 microns to about 30 microns, from about 30 microns to about 35 microns, from about 35 microns to about 40 microns, from about 40 microns to about 45 microns, from about 45 microns to about 50 microns, from about 50 microns to about 55 microns, from about 55 microns to about 60 microns, from about 60 microns to about 65 microns, from about 65 microns to about 70 microns, or any combination of one or more of these ranges.

The abrasion process may employ any appropriate pressure and arrangement. In embodiments, the abrasive particles may be propelled by a fluid medium at a pressure greater than or equal to about 25 psi to less than or equal to about 70 psi, such as from about 25 psi to about 30 psi, from about 30 psi to about 35 psi, from about 35 psi to about 40 psi, from about 40 psi to about 45 psi, from about 45 psi to about 50 psi, from about 50 psi to about 55 psi, from about 55 psi to about 60 psi, from about 60 psi to about 65 psi, from about 65 psi to about 70 psi, or combinations thereof, including any and all ranges formed from any of the foregoing endpoints.

In one or more embodiments, the fluid medium propelling the abrasive particles may be air. In embodiments, the abrasive particles are propelled from a nozzle at a distance from the surface of greater than or equal to about 5 cm to less than or equal to about 20 cm, such as greater than or equal to about 6 cm to less than or equal to about 19 cm, greater than or equal to about 7 cm to less than or equal to about 18 cm, greater than or equal to about 8 cm to less than or equal to about 17 cm, greater than or equal to about 9 cm to less than or equal to about 16 cm, greater than or equal to about 10 cm to less than or equal to about 15 cm, greater than or equal to about 11 cm to less than or equal to about 14 cm, greater than or equal to about 12 cm to less than or equal to about 13 cm, and any and all sub-ranges formed from any of the foregoing endpoints.

The nozzle may be positioned such that the abrasive particles are propelled against the surface of the glass-based substrate at any angle from orthogonal to the surface, wherein an angle of 0° indicates that the abrasive particles are propelled along a path orthogonal to the surface. In embodiments, the abrasive particles are propelled against the surface of the glass-based substrate at any angle from orthogonal to the surface of greater than or equal to about 0° to less than or equal to about 90°, such as greater than or equal to about 5° to less than or equal to about 85°, greater than or equal to about 10° to less than or equal to about 80°, greater than or equal to about 15° to less than or equal to about 75°, greater than or equal to about 20° to less than or equal to about 70°, greater than or equal to about 25° to less than or equal to about 65°, greater than or equal to about 30° to less than or equal to about 60°, greater than or equal to about 35° to less than or equal to about 55°, greater than or equal to about 40° to less than or equal to about 50°, and any and all sub-ranges formed from any of the foregoing endpoints.

After the abrasion process, the etching process may be selected to achieve a surface removal rate that provides the desired etching speed. In general, faster etching rates are desired, as fast etching rates increase manufacturing throughput. However, when an etching rate is too high surface uniformity may be reduced and cosmetic defects may develop. The etching rate is a function of the etchant, the temperature of the etchant and the composition of the glass-based substrate. In one or more embodiments, the etching may occur at a surface removal rate of less than or equal to about 22 microns/hour, such as less than or equal to about 20 microns/hour, less than or equal to about 18 microns/hour, less than or equal to about 16 microns/hour, less than or equal to about 14 microns/hour, less than or equal to about 12 microns/hour, less than or equal to about 10 microns/hour, less than or equal to about 8 microns/hour, less than or equal to about 6 microns/hour, less than or equal to about 4 microns/hour, or less.

The etching may be conducted for time period sufficient to produce the desired surface properties, such as opacity and roughness Rₐ. In embodiments the glass-based substrate may be etched for a time-period of from about 30 minutes to about 600 minutes, such as from about 50 minutes to about 575 minutes, from about 75 minutes to about 550 minutes, from about 100 minutes to about 525 minutes, from about 125 minutes to about 500 minutes, from about 150 minutes to about 475 minutes, from about 175 minutes to about 450 minutes, from about 200 minutes to about 425 minutes, from about 225 minutes to about 400 minutes, from about 250 minutes to about 375 minutes, from about 275 minutes to about 350 minutes, from about 300 minutes to about 325 minutes, and any and all sub-ranges formed from the foregoing endpoints.

The etchant may be chosen for desired etching properties, such as desired surface properties of the etched substrate or etching speed. In one or more embodiments, the etchant is an aqueous hydroxide solution with a hydroxide concentration of greater than or equal to about 5 wt. % to less than or equal to about 70 wt. %, such as greater than or equal to about 10 wt. % to less than or equal to about 65 wt. %, greater than or equal to about 15 wt. % to less than or equal to about 60 wt. %, greater than or equal to about 20 wt. % to less than or equal to about 55 wt. %, greater than or equal to about 25 wt. % to less than or equal to about 50 wt. %, greater than or equal to about 30 wt. % to less than or equal to about 45 wt. %, greater than or equal to about 35 wt. % to less than or equal to about 40 wt. %, and any and all sub-ranges formed from any of the foregoing endpoints. In embodiments, the etchant includes NaOH, KOH, or combinations thereof. The etchant may be substantially free or free of hydrofluoric acid. In one or more embodiments, the textured articles 100 described herein are produced without employing hydrofluoric acid.

The etchant may be at an elevated temperature during the etching process. The elevated temperature may increase the etching rate. In embodiments, the etchant is at a temperature of greater than or equal to about 90° C. to less than or equal to about 150° C., such as greater than or equal to about 95° C. to less than or equal to about 145° C., greater than or equal to about 100° C. to less than or equal to about 140° C., greater than or equal to about 105° C. to less than or equal to about 135° C., greater than or equal to about 110° C. to less than or equal to about 130° C., greater than or equal to about 115° C. to less than or equal to about 125° C., and any and all sub-ranges formed from the foregoing endpoints.

The etching rate and etching time may be selected to remove a desired amount of material from the surface of the glass-based substrate. If the amount of material removed in the etching step is too low the desired surface properties, such as opacity and roughness Rₐ, may not be achieved. Removing too much material from the abraded surface may increase cost and reduce manufacturing throughput. In embodiments, the etching process may remove greater than or equal to about 5 microns to less than or equal to about 60 microns from the abraded surface, such as greater than or equal to about 10 microns to less than or equal to about 55 microns, greater than or equal to about 15 microns to less than or equal to about 50 microns, greater than or equal to about 20 microns to less than or equal to about 45 microns, greater than or equal to about 25 microns to less than or equal to about 40 microns, greater than or equal to about 30 microns to less than or equal to about 35 microns and any and all ranges formed from the foregoing endpoints. The amount of material removed from the abraded surface is measured in the thickness direction of the textured articles 100 by micrometer unless otherwise indicated.

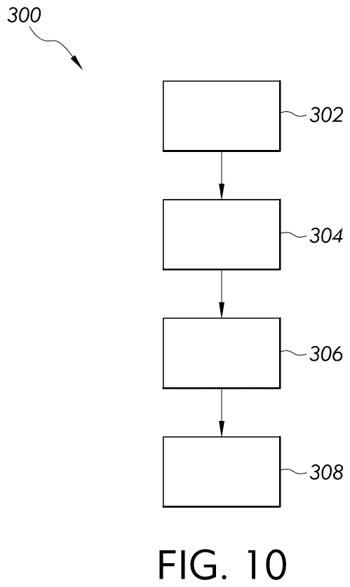

Now referring to FIG. 10 a flowchart 300 for a method of making a textured article according to one or more embodiments described herein is depicted. Generally the method may comprise at least steps 304 of abrading at least a portion of a first major surface, a second major surface, or both, of a glass-based substrate to form an abraded surface also step 306 of etching the abraded surface with an etchant to form a textured glass-based substrate. As shown in FIG. 10, the method may also optionally include pre-texturing processing step 302 and post-texturing processing step 308.

Abrading step 304 and etching step 306 may be performed as described in detail hereinabove. In optional pre-texturing processing step 302 the glass-based article may be prepared for subsequent steps. This may include sizing or cleaning of the glass-based article. Additionally, step 302 may include applying a mask or cover to portions of the glass-based article in which texturing is not desired. Examples of suitable masking techniques and materials are provided in U.S. Provisional Patent Application 63/236,882 (filed Aug. 25, 2021), the teachings of which are incorporated by reference herein. Such steps are contemplated as optional in the embodiments described herein.

Optional post-texturing processing step 308 may include removal of the mask (if a mask was used), ion exchange of the textured glass-based article 100, or application of colored films as described herein. The ion exchanging step may include ion exchanging the etched glass-based substrate with a molten salt bath to form a glass-based articles 100 that includes a compressive stress layer extending from a surface thereof to a depth of compression.

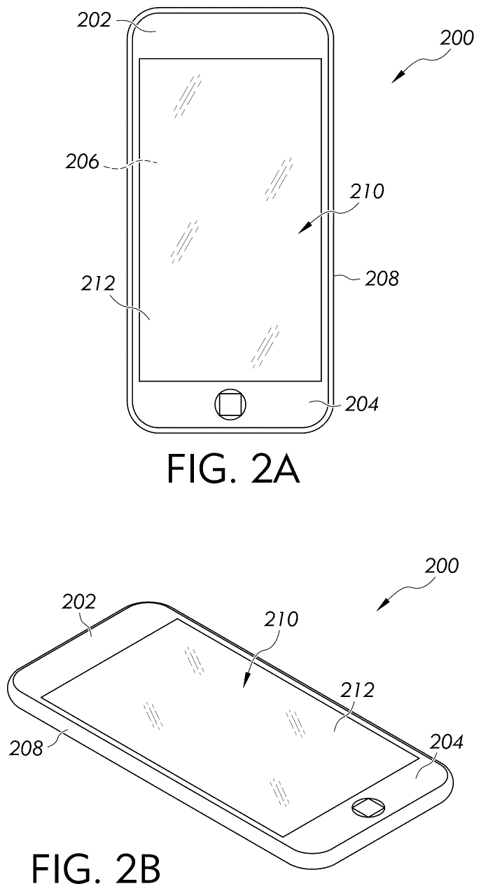

The textured articles 100 disclosed herein, as-formed or following ion exchanged, may be incorporated into another article such as an article with a display (or display articles) (e.g., consumer electronics, including mobile phones, tablets, computers, navigation systems, and the like), architectural articles, transportation articles, also referred to herein as vehicles, (e.g., automobiles, trains, aircraft, sea craft, etc.), appliance articles, or any article that requires some transparency, scratch-resistance, abrasion resistance or a combination thereof. An exemplary article incorporating any of the textured articles disclosed herein is shown in FIGS. 2A and 2B. Specifically, FIGS. 2A and 2B show a consumer electronic product 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of the housing 202 not including the display 210 may include any of the textured articles disclosed herein.

As described above, the textured articles 100 described herein can be used as a front or back cover for mobile electronic devices. The textured articles 100 not only serve as protective covers but also serve to enable various functionalities of the mobile electronic devices. For example, the textured articles 100 may improve the touch feel, and may also provide a desirable aesthetic appearance.

Additional exemplary articles incorporating the textured articles disclosed herein are shown in FIGS. 12 and 13. Specifically, FIG. 12 depicts a gear knob 300 with a first surface 302 forming a flat top and a second surface 304 that forms the body of the gear knob. In one or more embodiments, one or more of the first surface 302 and the second surface 304 may comprise a glass bases substrate and one or both of first surface 302 and the second surface 304 may comprise the textured articles disclosed herein. FIG. 13 depicts a car interior 400 comprising a number of vehicle parts, such as a steering wheel 402, decorative trim 404, pillar cover 406, door handle 408, gear knob 300, dial 410, and button 412. In one or more embodiments, one or more of these vehicle parts may comprise any of the textured articles described herein.

### EXAMPLES

Embodiments will be further clarified by the following examples. It should be understood that these examples are not limiting to the embodiments described above.

### Example 1

Glass samples were used that were formed per the present disclosure from the compositions listed in Table 5. Sample A was a colorless glass-substrate composition as described in the present disclosure. Sample B was a black glass-substrate composition as described in the present disclosure. Samples C and D were white glass-substrate compositions as described in the present disclosure. Sample E was a colorless glass-substrate composition as described in the present disclosure. The samples were then subjected to the blasting conditions of Table 6 and the etching conditions of Table 7. In Table 6, conditions 1 to 14 were used on Sample A and conditions 13 to 18 were used on Samples B, C, and D. In Table 7, conditions 1 to 9 were used on Sample A and conditions 10 to 12 were used on Samples B, C, and D. For all samples the surface properties of the textured glass were measured on a Zygo 9000 with the following settings: Scan size was 870 microns by 870 microns; Objective: 20× Mirau; Image Zoom 0.5×; Camera resolution 0.873 microns; Scan Length: 40 microns

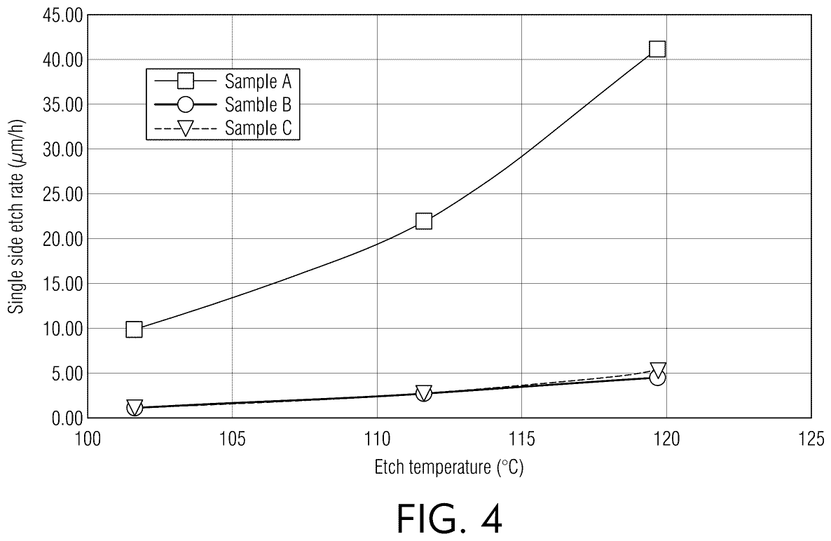

The single sided etch rate in microns/hr of Samples A-C at different etch temperatures is shown in FIG. 4. As shown in FIG. 4, the etch rate of a sample is influenced by both the glass composition and the etch temperature with increased etch temperature corresponding to an increase in single side etch rate.

TABLE 5

| Composition | Sample A | Sample B | Sample C | Sample D | Sample E |
|---|---|---|---|---|---|
| (mol % ) | (Colorless) | (Black) | (White) | (White) | (Colorless) |
| SiO₂ | 63.6 | 68.8 | 70.8 | 69.6 | 67.3 |
| B₂O₃ | 2.4 | 0.0 | 0.0 | 0.0 | 1.4 |
| P₂O₅ | 2.5 | 1.0 | 0.9 | 1.0 | 1.6 |
| Al₂O₅ | 15.1 | 4.8 | 4.3 | 4.0 | 13.6 |
| Li₂O | 6.0 | 18.3 | 22.1 | 22.4 | 6.6 |
| Na₂O | 9.3 | 1.8 | 0.0 | 0.1 | 6.0 |
| ZnO | 1.2 | 0.0 | 0.0 | 0.0 | 0.8 |
| ZrO₂ | 0.0 | 1.6 | 2.0 | 2.8 | 0.0 |
| TiO₂ | 0.0 | 1.9 | 0.0 | 0.0 | 0.0 |
| SnO₂ | 0.0 | 0.1 | 0.0 | 0.0 | 0.1 |
| Fe₂O₃ | 0.0 | 0.9 | 0.0 | 0.0 | 0.0 |
| NiO | 0.0 | 0.7 | 0.0 | 0.0 | 0.0 |
| Co₃O₄ | 0.0 | 0.1 | 0.0 | 0.0 | 0.0 |
| MgO | 0.0 | 0.0 | 0.0 | 0.0 | 2.9 |

TABLE 6

| | Particle | Time | Pressure |
|---|---|---|---|
| | Size | (mins) | (psi) |
| SB Condition 1 | 20 | 2 | 25 |
| SB Condition 2 | 20 | 4 | 25 |
| SB Condition 3 | 20 | 2 | 50 |
| SB Condition 4 | 20 | 4 | 50 |
| SB Condition 5 | 40 | 2 | 25 |
| SB Condition 6 | 40 | 4 | 25 |
| SB Condition 7 | 40 | 2 | 50 |
| SB Condition 8 | 40 | 4 | 50 |
| SB Condition 9 | 70 | 2 | 25 |
| SB Condition 10 | 70 | 4 | 25 |
| SB Condition 11 | 70 | 2 | 50 |
| SB Condition 12 | 70 | 4 | 50 |
| SB Condition 13 | 20 | 8 | 25 |
| SB Condition 14 | 20 | 8 | 50 |
| SB Condition 15 | 40 | 8 | 25 |
| SB Condition 16 | 40 | 8 | 50 |
| SB Condition 17 | 70 | 8 | 25 |
| SB Condition 18 | 70 | 8 | 50 |

TABLE 7

| | Etching Target | | Etching |
|---|---|---|---|
| | single side | Etching | Temperature |
| | (microns) | Solution | (° C.) |
| Etch Condition 1 | 5 | 50% NaOH | 110 |
| Etch Condition 2 | 10 | 50% NaOH | 110 |
| Etch Condition 3 | 20 | 50% NaOH | 110 |
| Etch Condition 4 | 20 | 50% NaOH | 110 |
| Etch Condition 5 | 25 | 50% NaOH | 110 |
| Etch Condition 6 | 35 | 50% NaOH | 110 |
| Etch Condition 7 | 40 | 50% NaOH | 110 |
| Etch Condition 8 | 45 | 50% NaOH | 110 |
| Etch Condition 9 | 55 | 50% NaOH | 110 |
| Etch Condition 10 | 35 | 50% NaOH | 120 |
| Etch Condition 11 | 45 | 50% NaOH | 120 |
| Etch Condition 12 | 55 | 50% NaOH | 120 |

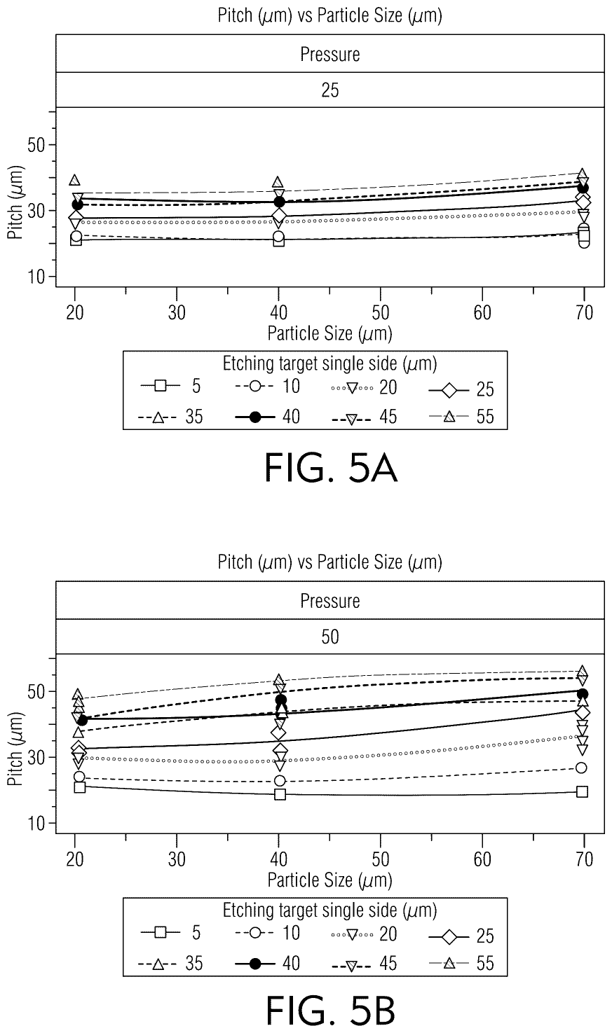

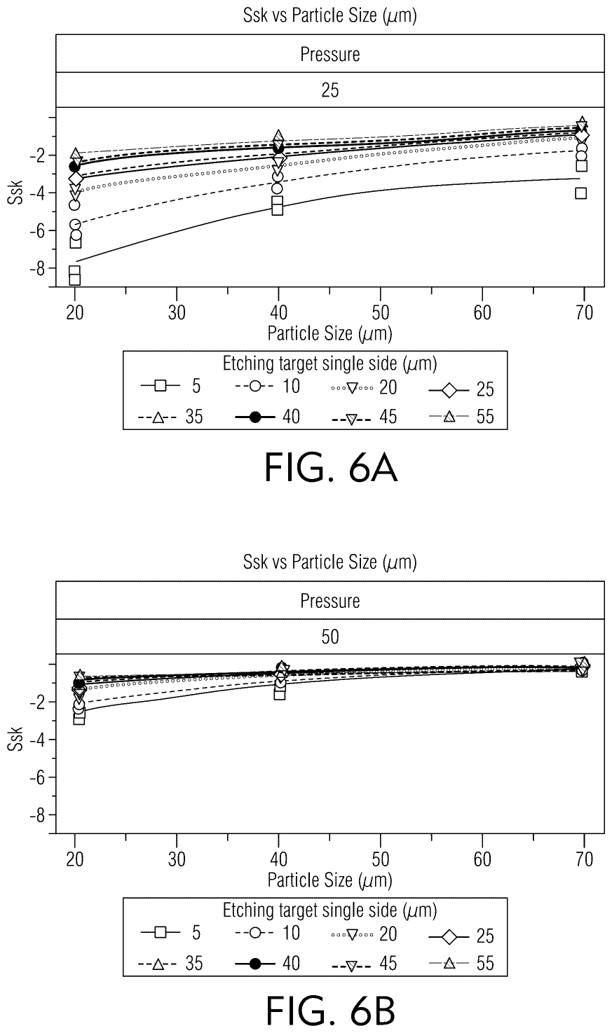

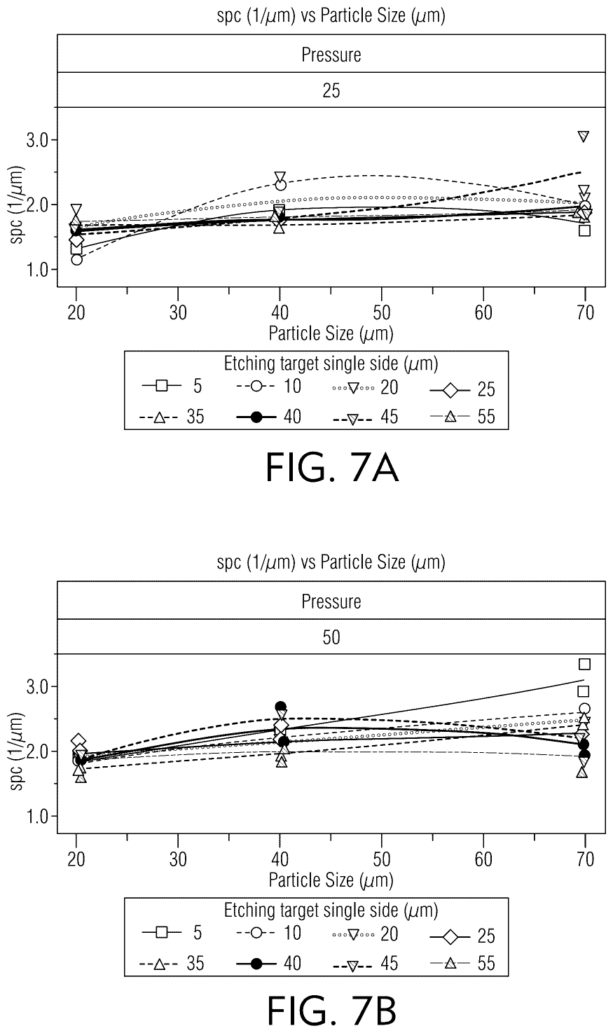

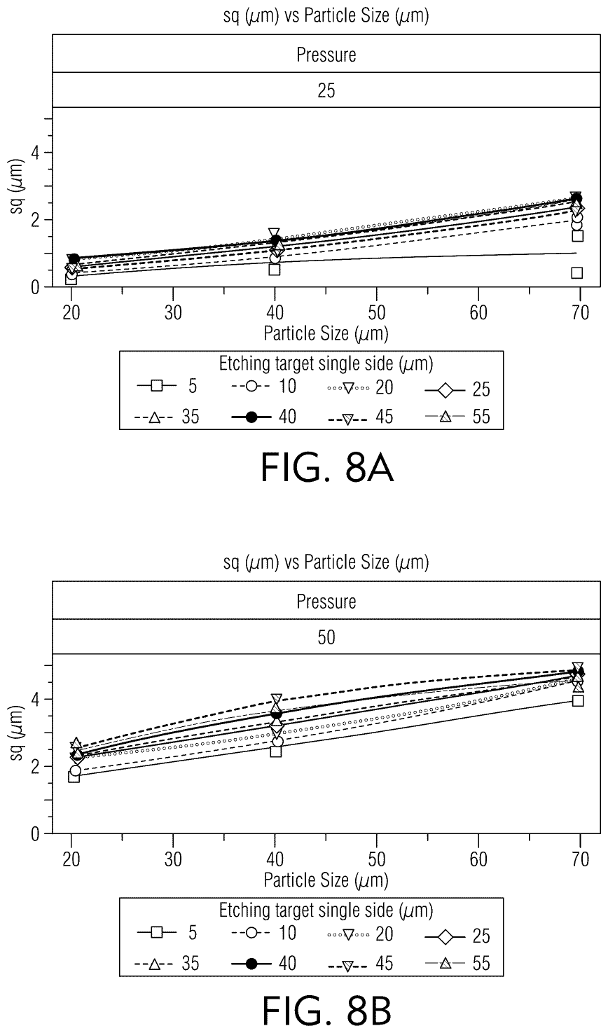

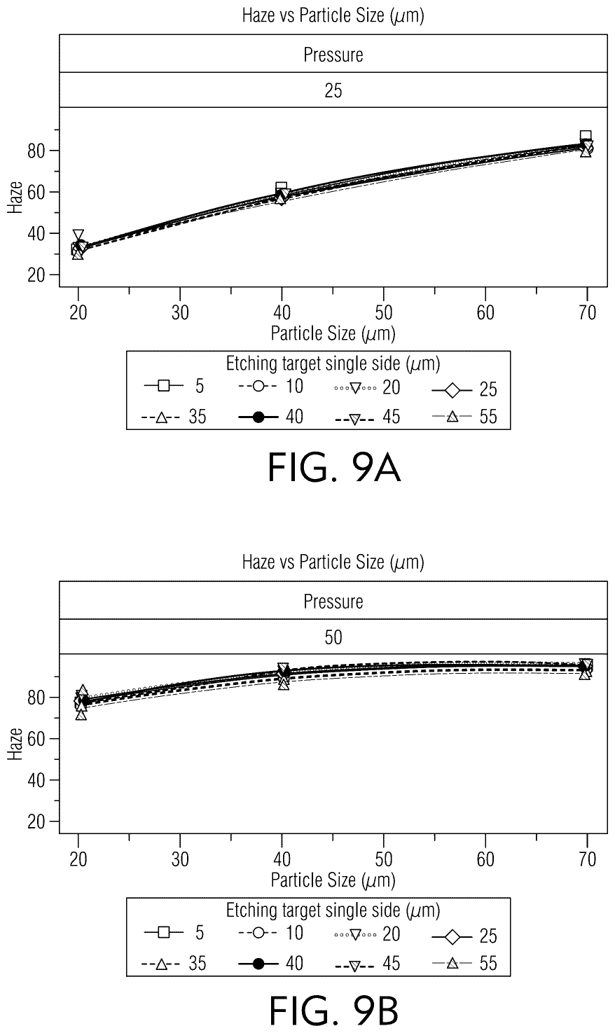

FIGS. 5A-9B show the effect of sandblast particle size, pressure, and single side etching target on the properties of Sample A. FIGS. 5A and 5B show that the size of pitch increases with more etching to form larger surface features, particle size has only a small effect on the pitch of the sample, and for higher etching target higher pressure generally corresponded to higher pitch. FIGS. 6A and 6B show that the degree of skewness/asperity (Ssk) improves with higher etching targets. FIGS. 7A and 7B, show that the arithmetic mean peak curvature (Spc) generally decreased with more etching, indicating that increased etching smoothed the peaks of the surface features of the textured surface. FIGS. 8A and 8B, show that the root mean square height of the surface features (Sq) increased with increasing particle size and pressure and etching target has only a small effect on the Sq of the surface. FIGS. 9A and 9B show that the haze of the surface features increased with both increasing particle size and pressure, but the etch conditions had little effect on the haze of the samples. For most tested conditions the haze of the samples was greater than 40%.

Table 8 shows surface texture properties of Sample A after undergoing different sandblast and etch conditions. Table 9 shows surface texture properties of Sample B after undergoing different sandblast and etch conditions.

TABLE 8

| | | Sample A | Sample A |
|---|---|---|---|
| | | SB Condition 6 | SB Condition 6 |
| Texture | | Etch Condition | Etch Condition |
| Property | Units | 7 | 8 |
| Sa | microns | 1.17 | 1.14 |
| Sq | microns | 1.53 | 1.47 |
| Ssk | — | −1.68 | −1.62 |
| Rsm | microns | 41.3 | 40.9 |
| Pitch | microns | 38.3 | 39 |
| Ra | microns | 0.64 | 0.62 |

As shown in Table 8, the pitch of the features from both tested conditions were larger than 30 microns. Generally, the parameter results in Table 8, indicate that both sets of conditions would produce a sample that would be well suited for non-display applications, such as a trackpad, chin, backcover, etc.

TABLE 9

| | | Sample B | Sample B |
|---|---|---|---|
| | | SB Condition | SB Condition |
| | | 15 | 15 |
| Texture | | Etch Condition | Etch Condition |
| Property | Units | 10 | 11 |
| Sa | microns | 1.26 | 1.22 |
| Sq | microns | 1.61 | 1.59 |
| Ssk | — | −1.13 | −1.2 |
| Rsm | microns | 39.36 | 40.13 |
| Pitch | microns | 41.2 | 44.23 |
| Ra | microns | 0.68 | 0.64 |

As shown in Table 0, the size of the surface features under both tested sets of conditions was larger than 30 microns as shown by pitch and Rsm. Generally, the parameter results in Table 9, indicate that both sets of conditions would produce a sample that would be well suited for non-display applications, such as a trackpad, chin, backcover, etc.

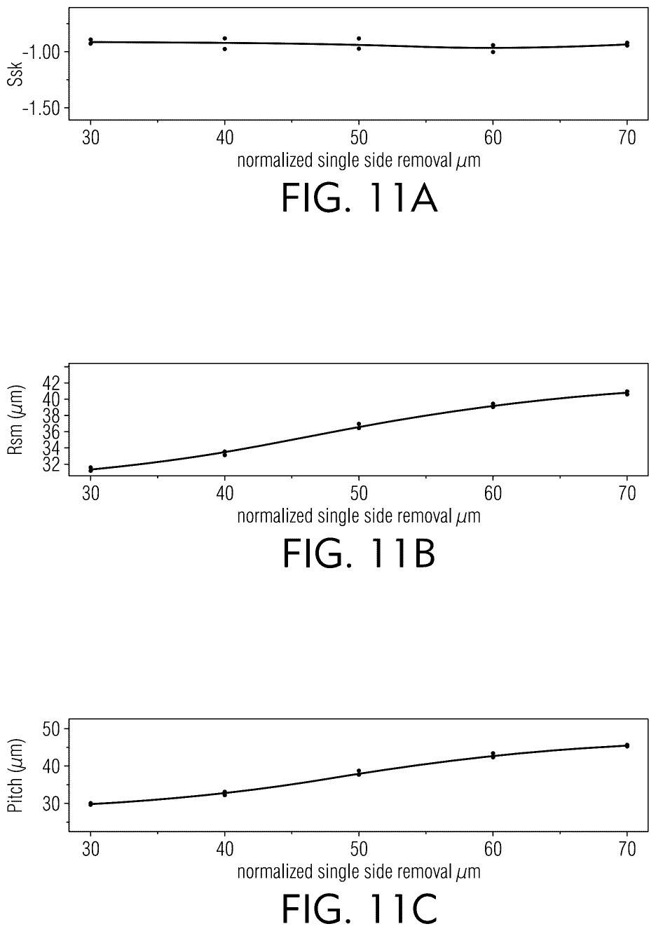

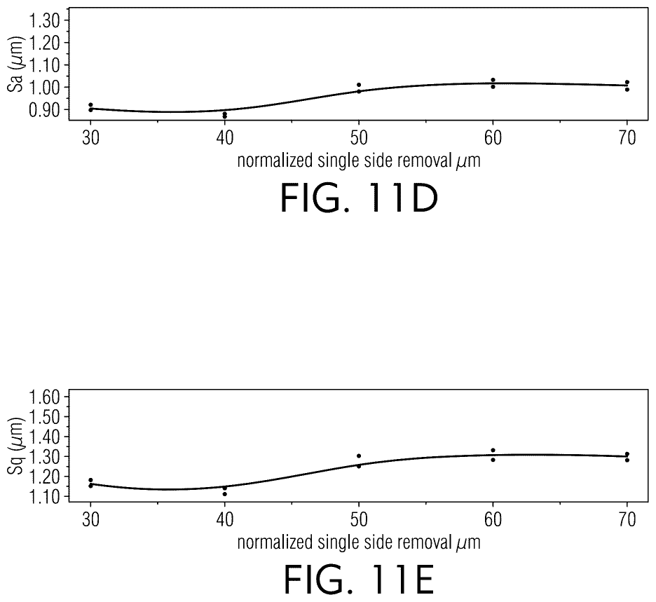

FIGS. 11A-11E show the effect of single side etching target on the properties of Sample E. The sandblast particle size used was from 7-12 microns with a pressure of from 40-70 psi. As can be seen in FIGS. 11B and 11C pitch and Rsm both increased with more etching indicating larger texture size on the glass. FIGS. 11A, 11D, and 11E show that Ssk, Sa, and Sq also increase slightly with increased etching.

Table 10 shows the surface properties of Sample E after undergoing sandblasting and etching. Sandblasting was performed with a particle size of from 7-12 microns and at a pressure of from 40-70 psi. The single side removal etching target was 50 microns.

TABLE 10

| Texture | | |
|---|---|---|
| Property | Units | Sample E |
| Sa | microns | 0.98 |
| Sq | microns | 1.25 |
| Ssk | — | −0.89 |
| Rsm | microns | 36.45 |
| Pitch | microns | 37.6 |
| Ra | microns | 0.57 |

As shown in Table 10, the size of the surface features was larger than 30 microns, as shown by pitch and Rsm. Generally, the parameter results in Table 10, indicate the conditions would produce a sample that would be well suited for non-display applications, such as a trackpad, chin, backcover, etc.

### Example 2

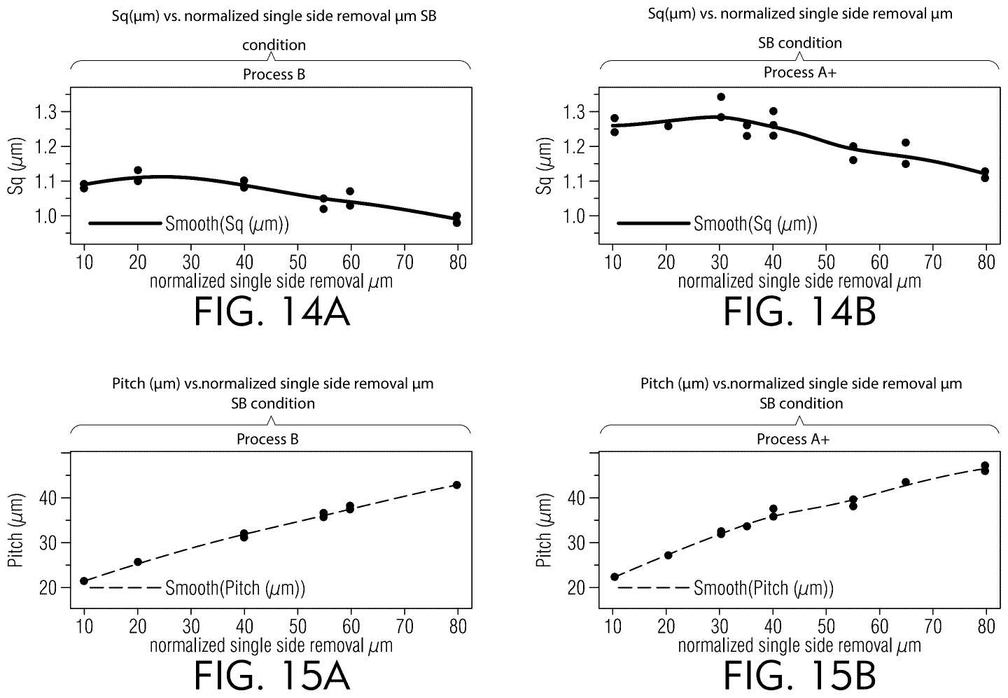

Glass samples were used that were formed per the present disclosure from the composition listed in Table 11. The samples were then subjected to the blasting conditions of Table 12 and the etching conditions of Table 13. The surface properties of the various samples were recorded in FIGS. 14A-17B and in Table 14. For all samples the surface properties of the textured glass were measured on a Zygo 9000 with the following settings: Scan size was 870 microns by 870 microns; Objective: 20× Mirau; Image Zoom 0.5×; Camera resolution 0.873 microns; Scan Length: 40 microns.

TABLE 11

| Composition | Sample F |
|---|---|
| (mol %) | (Colorless) |
| SiO₂ | 67.23 |
| B₂O₃ | 3.63 |
| K₂O | 0.01 |
| Al₂O₅ | 12.72 |
| Na₂O | 13.91 |
| CaO | 0.05 |
| ZrO₂ | 0.01 |
| SnO₂ | 0.09 |
| Fe₂O₃ | 0.01 |
| MgO | 2.34 |

TABLE 12

| Sandblast | Particle | Pressure, | Distance, | |
|---|---|---|---|---|
| Condition | Size, um | psi | inch | Angle |
| 19 | 30 | 65 | 3 | 90 |
| 20 | 40 | 60 | 3 | 90 |

TABLE 13

| | | Etching target |
|---|---|---|
| Etching | Etching | single side |
| solution | Temp. | removal, um |
| 50% NaOH | 120° C. | 10 |
| | | 20 |
| | | 30 |
| | | 40 |
| | | 50 |
| | | 60 |
| | | 70 |
| | | 80 |

TABLE 14

| | single | | | | | | | |
|---|---|---|---|---|---|---|---|---|
| | side | | | | | | | |
| | removal | Ra | Sq | | Pitch | Ssc | | Gloss |
| Sample | μm | μm | μm | Sdq | μm | 1/μm | Haze | 60 |
| 1 | 10 | 0.68 | 1.09 | 0.46 | 21.08 | 0.18 | 92.3 | 14.9 |
| 2 | 10 | 0.68 | 1.08 | 0.46 | 20.95 | 0.18 | 92.4 | 14.9 |
| 3 | 20 | 0.65 | 1.13 | 0.37 | 25.53 | 0.15 | 82.7 | 13.5 |
| 4 | 20 | 0.64 | 1.1 | 0.36 | 25.51 | 0.15 | 82.2 | 13.5 |
| 5 | 10 | 0.76 | 1.28 | 0.5 | 22.43 | 0.19 | 93.5 | 15.1 |
| 6 | 10 | 0.75 | 1.24 | 0.5 | 22.12 | 0.19 | 93.3 | 15.1 |
| 7 | 20 | 0.7 | 1.26 | 0.39 | 27.05 | 0.16 | 84.4 | 13.7 |
| 8 | 20 | 0.7 | 1.26 | 0.38 | 27.01 | 0.16 | 84.3 | 13.7 |

In Table 14, Samples 1-4 used sandblast condition 20 and Samples 5-8 used sandblast condition 19. As shown in table 13 under both sandblast conditions with a single side removal target of either 10 microns or 20 microns all samples would be well suited for non-display applications, such as a vehicle part, a trackpad, phone chin, or phone backcover.

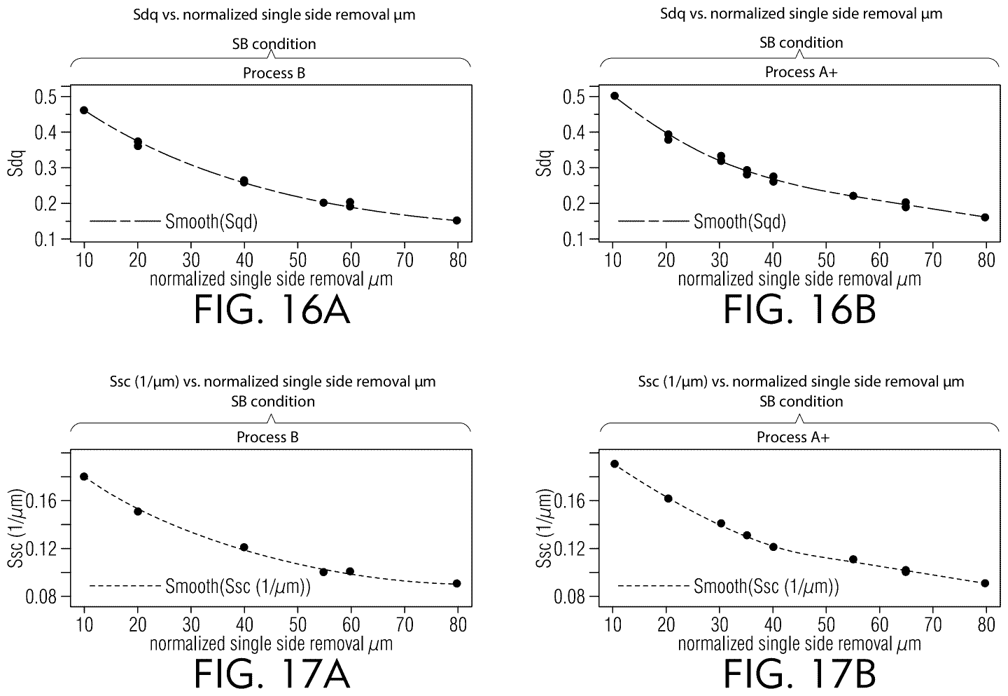

As see in FIGS. 14A and 14B the root mean square height of the samples decreased with increasing single side removal. As seen in FIGS. 15A and 15B, the size of the pitch of the glass samples increased with increasing single side removal. As see in FIGS. 16A and 16B the root mean square gradient of the glass samples decreased with increasing single side removal. As seen in FIGS. 17A and 17B the arithmetic mean peak curvature of the samples decreased with increasing single side removal. Accordingly, a balance of these effects was found to occur at from 10 μm to 30 μm single side removal.

Some of the etched and sandblasted samples were tested using a cheesecloth abrasion test, as is described in detail hereinabove. The results of this testing is reported in Table 15. In Table 15, samples 9-12 were formed using condition 19 from Table 12 and samples 13-16 were formed using condition 20 from Table 12.

TABLE 15

| | Single Side | Average Water | Average Water |
|---|---|---|---|
| | Removal | Contact Angle | Contact Angle |
| Sample | (microns) | Before Abrasion | After Abrasion |
| 9 | 40 | 112.556 | 107.864 |
| 10 | 80 | 113.816 | 104.296 |
| 11 | 10 | 117.954 | 113.364 |
| 12 | 20 | 114.522 | 109.114 |
| 13 | 40 | 112.5 | 105.564 |
| 14 | 80 | 112.598 | 95.704 |
| 15 | 10 | 117.6 | 114.258 |
| 16 | 20 | 113.044 | 112.306 |

As shown in Table 15, samples 11-12 and 15-16, which all had single side removal targets of from 10 to 20 microns, all had average water contact angles after abrasion indicating that the glass samples would be well suited for non-display applications, such as a vehicle part, a trackpad, phone chin, or phone backcover.

Additionally, some of the etched and sandblasted samples were tested using a chemical durability test in which a sample of glass was submerged in a reagent under the conditions listed in Table 16. The weight loss of the samples was also recorded in Table 16.

TABLE 16

| | | Time | Temperature | Weight Loss |
|---|---|---|---|---|
| Sample | Reagent | hours | ° C. | mg/cm² |
| 17 | HCl-5% | 24 | 95 | 0.6 |
| 18 | NaOH-5% | 6 | 95 | 1.9 |

Further, some samples were tested using a coefficient of friction test, as described in detail hereinabove. The results of this testing was recorded in Table 17. In Table 17 samples 19-26 were prepared using condition 19 from Table 12 and samples 27-34 were prepared using condition 20 from Table 12.

TABLE 17

| | Single | | Static Coefficient | | Kinetic Coefficient | |
|---|---|---|---|---|---|---|
| | Side | Easy to | of Friction | | of Friction | |
| | Removal | Clean | | Std. | | Std. |
| Sample | (microns) | Coating | Average | Dev. | Average | Dev. |
| 19 | 40 | No | 0.251 | 0.021 | 0.220 | 0.019 |
| 20 | 40 | Yes | 0.160 | 0.003 | 0.149 | 0.001 |
| 21 | 80 | No | 0.211 | 0.018 | 0.196 | 0.021 |
| 22 | 80 | Yes | 0.114 | 0.002 | 0.106 | 0.002 |
| 23 | 10 | No | 0.426 | 0.036 | 0.389 | 0.024 |
| 24 | 10 | Yes | 0.329 | 0.014 | 0.309 | 0.005 |
| 25 | 20 | no | 0.300 | 0.014 | 0.290 | 0.018 |
| 26 | 20 | Yes | 0.223 | 0.007 | 0.211 | 0.003 |
| 27 | 40 | No | 0.248 | 0.015 | 0.229 | 0.018 |
| 28 | 40 | Yes | 0.156 | 0.002 | 0.147 | 0.001 |
| 29 | 80 | no | 0.203 | 0.020 | 0.185 | 0.021 |
| 30 | 80 | Yes | 0.104 | 0.000 | 0.097 | 0.001 |
| 31 | 10 | No | 0.378 | 0.027 | 0.346 | 0.019 |
| 32 | 10 | Yes | 0.304 | 0.006 | 0.294 | 0.004 |
| 33 | 20 | no | 0.305 | 0.021 | 0.289 | 0.016 |
| 34 | 20 | yes | 0.224 | 0.007 | 0.210 | 0.003 |

As shown in table 17, samples with a single side removal target of either 10 microns or 20 microns (e.g., Samples 23-26 and 31-34) had a suitable coefficient of friction for use in non-display applications.

In a first aspect of the present disclosure a textured article may comprise a glass-based substrate comprising a first major surface and a second major surface opposite the second major surface. At least a portion of the first major surface may be textured and may have a roughness Rₐ of greater than or equal to 400 nm and an average pitch, where a ratio of roughness Rₐ to average pitch is from 0.01 to 0.04. At least a portion of the textured article has one or both of an opacity of greater than about 70% or has a coefficient of friction of from about 0.25 to about 0.4, wherein the coefficient of friction is measured as the kinetic coefficient of friction using a 500 g load on a foam rubber according to ASTM D1984.

A second aspect of the present disclosure may include the first aspect where, the glass-based substrate has transmittance color coordinates in the (L*, a*, b*) colorimetry system at normal incidence under an International Commission on Illumination illuminant of: L*: about 25 to about 32, a*: about −0.5 to about 0, and b*: about −1.5 to about 0.

A third aspect of the present disclosure may include the first aspect where, the glass-based substrate has transmittance color coordinates in the (L*, a*, b*) colorimetry system at normal incidence under an International Commission on Illumination illuminant of L*: about 90 to about 98, a*: about −0.75 to about 0, and b*: about −2 to about 0.

A fourth aspect of the present disclosure may include the first aspect where the glass-based substrate is colorless or transparent and the textured article further comprises a colored film.

A fifth aspect of the present disclosure may include any previous aspect or combination of aspects where the portion of the first major surface that is textured has a roughness Rₐ of from about 400 nm to about 2000 nm.

A sixth aspect of the present disclosure may include any previous aspect or combination of aspects where at least a portion of the textured article has an opacity of greater than about 80%.

A seventh aspect of the present disclosure may include any previous aspect or combination of aspects where at least a portion of the textured article has a haze of at least about 40%.

An eighth aspect of the present disclosure may include any previous aspect or combination of aspects where the entire first major surface is textured.

A ninth aspect of the present disclosure may include any previous aspect or combination of aspects where at least a portion of the second major surface is textured.

A tenth aspect of the present disclosure may include any previous aspect or combination of aspects where the entire first and second major surfaces are textured.

An eleventh aspect of the present disclosure may include any previous aspect or combination of aspects where the glass-based substrate comprises glass ceramic.

A twelfth aspect of the present disclosure may include any of the first, third, and fifth to eleventh aspects where the glass-based substrate has a composition comprising about 55.0 wt. % to about 75.0 wt. % SiO₂, about 2.0 wt. % to about 20.0 wt. % Al₂O₃, about 0 wt. % to about 5.0 wt. % B₂O₃, about 5.0 wt. % to about 15.0 wt. % Li₂O, about 0 wt. % to about 5.0 wt. % Na₂O, about 0 wt. % to about 4.0 wt. % K₂O, about 0 wt. % to about 8.0 wt. % MgO, about 0 wt. % to about 10.0 wt. % ZnO, about 0.5 wt. % to about 5.0 wt. % TiO₂, about 1.0 wt. % to about 6.0 wt. % P₂O₅, about 2.0 wt. % to about 10.0 wt. % ZrO₂, about 0 wt. % to about 0.4 wt. % CeO₂, about 0.05 wt. % to about 0.5 wt. % SnO+SnO₂, about 0.1 wt. % to about 5.0 wt. % FeO+Fe₂O₃, about 0.1 wt. % to about 5.0 wt. % NiO, about 0.1 wt. % to about 5.0 wt. % Co₃O₄, about 0 wt. % to about 4.0 wt. % MnO+MnO₂+Mn₂O₃, about 0 wt. % to about 2.0 wt. % Cr₂O₃, about 0 wt. % to about 2.0 wt. % CuO, and about 0 wt. % to about 2.0 wt. % V₂O₅.

A thirteenth aspect of the present disclosure may include any of the first, second, and fifth to eleventh aspects where the glass-based substrate has a composition comprising about 55.0 wt. % to about 80.0 wt. % SiO₂, about 2.0 wt. % to about 20.0 wt. % Al₂O₃, about 5.0 wt. % to about 20.0 wt. % Li₂O, about 0.0 wt. % to about 10.0 wt. % B₂O₃, about 0.0 wt. % to about 5.0 wt. % Na₂O, about 0.0 wt. % to about 10.0 wt. % ZnO, about 0.5 wt. % to about 6.0 wt. % P₂O₅, and about 0.2 wt. % to about 15.0 wt. % ZrO₂.

A fourteenth aspect of the present disclosure may include any of the first and fourth to eleventh aspects where the glass-based substrate has a composition comprising about 60.0 mol % to about 80.0 mol % SiO₂, about 10.0 mol % to about 20.0 mol % Al₂O₃, about 4.0 mol % to about 6.0 mol % Li₂O, about 4.5 mol % to about 12.0 mol % Na₂O, wherein the amount of Na₂O is greater than the amount of Li₂O, about 0.5 mol % to about 3.0 mol % ZnO, about 0.9 mol % to about 7.5 mol % B₂O₃, and about 0.0 mol % to about 10.0 mol % P₂O₅, wherein the total amount of B₂O₃, P₂O₅, SiO₂ and Al₂O₃ is about 80 mol % or greater. The ratio of Li₂O to the total amount of B₂O₃, P₂O₅, SiO₂ and Al₂O₃ is from about 0.065 to less than about 0.074. The glass-based substrate excludes glass-ceramic materials and the composition is free of nucleating agents.

A fifteenth aspect of the present disclosure may include any of the first and fourth to eleventh aspects where the glass-based substrate has a composition comprising about 60.0 mol. % to about 70.0 mol. % SiO₂, about 5.0 mol. % to about 20.0 mol. % Al₂O₃, about 1.0 mol. % to about 4.0 mol. % MgO, about 0.5 mol. % to about 10.0 mol. % Li₂O, about 0.45 mol. % to about 6 mol. % P₂O₅, about 0.0 mol. % to about 15.0 mol. % Na₂O, about 0.0 mol. % to about 5.0 mol. % B₂O₃, about 0.0 mol. % to about 1.0 mol. % ZnO, about 0.0 mol. % to about 0.5 mol. % K₂O, less than or equal to about 16.0 mol. % Alk₂O, and about 0.0 mol. % to about 1.5 mol. % REₘOₙ. The composition satisfies the condition: 0.85≤Alk₂O/Al₂O₃[mol. %] 1.2. The chemical formulas mean the content of corresponding components in the glass in mol % where Alk₂O is a total sum of alkali metal oxides, Li₂O+Na₂O+K₂O+Rb₂O+Cs₂O, and REₘOₙ is a total sum of rare earth metal oxides, La₂O₃+Y₂O₃+Gd₂O₃+Yb₂O₃+Lu₂O₃+Ce₂O₃+Pr₂O₃+Nd₂O₃+Sm₂O₃+Eu₂O₃+Tb₂O₃+Dy₂O₃+H0203+Er₂O₃+Tm₂O₃.

A sixteenth aspect of the present disclosure may include any previous aspect or combination of aspects, where the glass-based substrate is transparent, colored transparent, opaque, colored opaque, translucent, or colored translucent.

A seventeenth aspect of the present disclosure may include the first aspect, where the glass-based substrate has a composition comprising about 66 mol % to about 74 mol % SiO₂, at least about 10 mol % R₂O, wherein R₂O comprises about 9 mol % to about 20 mol % Na₂O, about 9 mol % to about 22 mol % Al₂O₃, wherein Al₂O₃ (mol %)<R₂O (mol %), and B₂O₃, wherein B₂O₃ (mol %)-(R₂O (mol %)-Al₂O₃ (mol %))≥2.25 mol %, and wherein the glass is ion exchangeable.

An eighteenth aspect of the present disclosure may include the seventeenth aspect, where the glass-based substrate is colorless or transparent and the textured article further comprises colored ink.

A nineteenth aspect of the present disclosure may include any previous aspect or combination of aspects where at least a portion of the textured article has an opacity of greater than about 70%.

A twentieth aspect of the present disclosure may include any previous aspect or combination of aspects where at least a portion of the textured article has a coefficient of friction of from about 0.25 to about 0.4.

A twenty-first aspect of the present disclosure may include any previous aspect or combination of aspects where both at least a portion of the textured article has an opacity of greater than about 70% and at least a portion of the textured article has a coefficient of friction of from about 0.25 to about 0.4.

A twenty-second aspect of the present disclosure may include any previous aspect or combination of aspects where at least a portion of the textured article has a cheesecloth-abraded water contact angle of from about 109° to about 114° after being subjected to 400,000 strokes using a cheesecloth.

A twenty-third aspect of the present disclosure may include any previous aspect or combination of aspects where the textured article comprises one or more curved surfaces.

A twenty-fourth aspect of the present disclosure may include any previous aspect or combination of aspects where the glass-based substrate is a cold formed glass sheet.

A twenty-fifth aspect of the present disclosure may include any previous aspect or combination of aspects where the textured article is a vehicle part or a portion of a vehicle part.

A twenty-sixth aspect of the present disclosure may include any previous aspect or combination of aspects where the vehicle part is chosen from a gear shifter, a knob for a gear shifter, a dial, an interior panel, a steering wheel, a door trim, a button, a key fob, a pillar cover, or a door handle.

A twenty-seventh aspect of the present disclosure may include any previous aspect or combination of aspects where the vehicle part is a gear shifter

A twenty-eighth aspect of the present disclosure may include a vehicle comprising a vehicle part where the textured article of any of the first to twenty-seventh aspects is the vehicle part or a portion of the vehicle part

A twenty-ninth aspect of the present disclosure may include a consumer electronic product, comprising a housing comprising a front surface, a back surface and side surfaces, electrical components at least partially within the housing, the electrical components comprising a controller, a memory, and a display, the display at or adjacent to the front surface of the housing, and a cover substrate disposed over the display. At least one of a portion of the housing not including the display comprises the textured article of any previous aspect of any of the first to twenty-fourth aspects.

A thirtieth aspect of the present disclosure may include a textured article comprising a glass-based substrate comprising a first major surface and a second major surface opposite the first major surface. At least a portion of the first major surface is textured and has a roughness Rₐ of greater than or equal to 400 nm, and an average pitch. The ratio of roughness Rₐ to average pitch is from about 0.01 to about 0.04. At least a portion of the textured article has one of the following: transmittance color coordinates in the (L*, a*, b*) colorimetry system at normal incidence under an International Commission on Illumination illuminant of L*: about 90 to about 98, a*: about −0.75 to about 0, and b*: about −2 to about 0 or transmittance color coordinates in the (L*, a*, b*) colorimetry system at normal incidence under an International Commission on Illumination illuminant of: L*: about 25 to about 32, a*: about −0.5 to about 0, and b*: about −1.5 to about 0.

A thirty-first aspect of the present disclosure may include the thirtieth aspect where at least a portion of the textured article has an opacity of greater than about 70%.

A thirty-second aspect of the present disclosure may include any of the thirtieth and thirty-first aspects where at least a portion of the textured article has an opacity of greater than about 80%.

A thirty-third aspect of the present disclosure may include any of the thirtieth to thirty-second aspects where at least a portion of the textured article has a haze of at least about 40%.

A thirty-fourth aspect of the present disclosure may include any of the thirtieth to thirty-third aspects where the portion of the first major surface that is textured has a roughness Rₐ of from about 400 nm to about 2000 nm.

A thirty-fifth aspect of the present disclosure may include any of the thirtieth to thirty-fourth aspects where the entire first major surface is textured.

A thirty-sixth aspect of the present disclosure may include any of the thirtieth to thirty-fifth aspects where at least a portion of the second major surface is textured.

A thirty-seventh aspect of the present disclosure may include any of the thirtieth to thirty-sixth aspects where the entire first and second major surfaces are textured.

A thirty-eighth aspect of the present disclosure may include any of the thirtieth to thirty-seventh aspects where the glass-based substrate comprises glass ceramic.

A thirty-ninth aspect of the present disclosure may include any of the thirtieth to thirty-eighth aspects where the glass-based substrate has a composition comprising about 55.0 wt. % to about 75.0 wt. % SiO₂, about 2.0 wt. % to about 20.0 wt. % Al₂O₃, about 0 wt. % to about 5.0 wt. % B₂O₃, about 5.0 wt. % to about 15.0 wt. % Li₂O, about 0 wt. % to about 5.0 wt. % Na₂O, about 0 wt. % to about 4.0 wt. % K₂O, about 0 wt. % to about 8.0 wt. % MgO, about 0 wt. % to about 10.0 wt. % ZnO, about 0.5 wt. % to about 5.0 wt. % TiO₂, about 1.0 wt. % to about 6.0 wt. % P₂O₅, about 2.0 wt. % to about 10.0 wt. % ZrO₂, about 0 wt. % to about 0.4 wt. % CeO₂, about 0.05 wt. % to about 0.5 wt. % SnO+SnO₂, about 0.1 wt. % to about 5.0 wt. % FeO+Fe₂O₃, about 0.1 wt. % to about 5.0 wt. % NiO, about 0.1 wt. % to about 5.0 wt. % Co₃O₄, about 0 wt. % to about 4.0 wt. % MnO+MnO₂+Mn₂O₃, about 0 wt. % to about 2.0 wt. % Cr₂O₃, about 0 wt. % to about 2.0 wt. % CuO, and about 0 wt. % to about 2.0 wt. % V₂O₅.

A fortieth aspect of the present disclosure may include any of the thirtieth to thirty-eighth aspects where the glass-based substrate has a composition comprising about 55.0 wt. % to about 80.0 wt. % SiO₂, about 2.0 wt. % to about 20.0 wt. % Al₂O₃, about 5.0 wt. % to about 20.0 wt. % Li₂O, about 0.0 wt. % to about 10.0 wt. % B₂O₃, about 0.0 wt. % to about 5.0 wt. % Na₂O, about 0.0 wt. % to about 10.0 wt. % ZnO, about 0.5 wt. % to about 6.0 wt. % P₂O₅, and about 0.2 wt. % to about 15.0 wt. % ZrO₂.

A forty-first aspect of the present disclosure may include a consumer electronic product, comprising a housing comprising a front surface, a back surface and side surfaces, electrical components at least partially within the housing, the electrical components comprising a controller, a memory, and a display, the display at or adjacent to the front surface of the housing, and a cover substrate disposed over the display. At least one of a portion of the housing not including the display comprises the textured article of any of the thirtieth to fortieth aspects.

A forty-second aspect of the present disclosure may include a method of making a textured article comprising abrading at least a portion of a first major surface, a second major surface, or both, of a glass-based substrate to form an abraded surface by propelling abrasive particles against the surface. Etching the abraded surface with an etchant to form a textured glass-based substrate. The etchant is an aqueous hydroxide solution with a hydroxide concentration of from about 5 wt. % to about 70 wt. %. Abrading the surface of the glass-based substrate is with an abrasive media having an average diameter of from about 7 microns to about 70 microns.

A forty-third aspect of the present disclosure may include the forty-second aspect where the abrasive particles are propelled by a fluid medium at a pressure of from about 25 psi to about 70 psi.

A forty-fourth aspect of the present disclosure may include any of the forty-second to forty-third aspects where the etchant is a non-HF etchant.

A forty-fifth aspect of the present disclosure may include any of the forty-second to forty-fourth aspects where the etchant comprises NaOH, KOH, or combinations thereof.

A forty-sixth aspect of the present disclosure may include any of the forty-second to forty-fifth aspects where the etchant is at a temperature of from about 90° C. to about 150° C.

A forty-seventh aspect of the present disclosure may include any of the forty-second to forty-sixth aspects where the etching is for a time period of from about 30 min to about 600 min.

A forty-eighth aspect of the present disclosure may include any of the forty-second to forty-seventh aspects where the etching removes from about 5 microns to about 60 microns of material from the abraded surface.

A forty-ninth aspect of the present disclosure may include any of the forty-second to forty-eighth aspects where the etching occurs at a surface removal rate of less than or equal to about 22 microns/hr.

A fiftieth aspect of the present disclosure may include any of the forty-second to forty-ninth aspects where the abrasive particles comprise at least one of sand, Al₂O₃. SiC, SiO₂, and combinations thereof.

A fifty-first aspect of the present disclosure may include any of the forty-second to fortieth aspects where the abrasive particles are propelled from a nozzle at a distance from the surface of from about 5 cm to about 20 cm.

A fifty-second aspect of the present disclosure may include any of the forty-second to forty-first aspects where the abrasive particles are propelled against the surface at an angle from orthogonal to the surface of greater than or equal to about 0° to less than or equal to about 90°.

A fifty-third aspect of the present disclosure may include any of the forty-second to fifty-second aspects where a portion of the one or both of the first major surface and the second major surface that are textured has a roughness Rₐ of greater than or equal to about 400 nm, a pitch of from about 15 microns to about 60 microns, a ratio of roughness Rₐ to pitch of from about 0.01 to about 0.04, an opacity of greater than about 70%, and a haze of at least about 40%.

A fifty-fourth aspect of the present disclosure may include the fifty-third aspect where the portion of the one or both of the first major surface and the second major surface that are textured have a roughness Rₐ of from about 400 nm to about 2000 nm.

What is claimed is:

1. A textured article comprising:
a glass-based substrate comprising a first major surface and a second major surface opposite the second major surface, wherein:
at least a portion of the first major surface is textured and has:
a roughness Rₐ of greater than or equal to about 400 nm; and
an average pitch, wherein a ratio of roughness Rₐ to average pitch is from about 0.01 to about 0.04; and
one or both of:
at least a portion of the textured article has an opacity of greater than about 70%; or
at least a portion of the textured article has a coefficient of friction of from about 0.25 to about 0.4, wherein the coefficient of friction is measured as the kinetic coefficient of friction using a 500 g load on a foam rubber according to ASTM D1984.

2. The textured article of claim 1, wherein the glass-based substrate has transmittance color coordinates in the (L*, a*, b*) colorimetry system at normal incidence under an International Commission on Illumination illuminant of:
L*: about 25 to about 32;
a*: about −0.5 to about 0; and
b*: about −1.5 to about 0.

3. The textured article of claim 1, wherein the glass-based substrate has transmittance color coordinates in the (L*, a*, b*) colorimetry system at normal incidence under an International Commission on Illumination illuminant of
L*: about 90 to about 98;
a*: about −0.75 to about 0; and
b*: about −2 to about 0.

4. The textured article of claim 1, wherein:
the glass-based substrate is colorless or transparent; and
the textured article further comprises a colored film.

5. The textured article of claim 1, wherein the portion of the first major surface that is textured has a roughness Rₐ of from about 400 nm to about 2000 nm.

6. The textured article of claim 1, wherein at least a portion of the textured article has an opacity of greater than about 80%.

7. The textured article of claim 1, wherein at least a portion of the textured article has a haze of at least about 40%.

8. The textured article of claim 1, wherein the glass-based substrate comprises glass ceramic.

9. The textured article of claim 1, wherein the glass-based substrate has a composition comprising:
about 55.0 wt. % to about 75.0 wt. % SiO₂;
about 2.0 wt. % to about 20.0 wt. % Al₂O₃;
about 0 wt. % to about 5.0 wt. % B₂O₃;
about 5.0 wt. % to about 15.0 wt. % Li₂O;
about 0 wt. % to about 5.0 wt. % Na₂O;
about 0 wt. % to about 4.0 wt. % K₂O;
about 0 wt. % to about 8.0 wt. % MgO;
about 0 wt. % to about 10.0 wt. % ZnO;
about 0.5 wt. % to about 5.0 wt. % TiO₂;
about 1.0 wt. % to about 6.0 wt. % P₂O₅;
about 2.0 wt. % to about 10.0 wt. % ZrO₂;
about 0 wt. % to about 0.4 wt. % CeO₂;
about 0.05 wt. % to about 0.5 wt. % SnO+SnO₂;
about 0.1 wt. % to about 5.0 wt. % FeO+Fe₂O₃;
about 0.1 wt. % to about 5.0 wt. % NiO;
about 0.1 wt. % to about 5.0 wt. % Co₃O₄;
about 0 wt. % to about 4.0 wt. % MnO+MnO₂+Mn₂O₃;
about 0 wt. % to about 2.0 wt. % Cr₂O₃;
about 0 wt. % to about 2.0 wt. % CuO; and
about 0 wt. % to about 2.0 wt. % V₂O₅.

10. The textured article of claim 1, wherein the glass-based substrate has a composition comprising:
about 55.0 wt. % to about 80.0 wt. % SiO₂;
about 2.0 wt. % to about 20.0 wt. % Al₂O₃;
about 5.0 wt. % to about 20.0 wt. % Li₂O;
about 0.0 wt. % to about 10.0 wt. % B₂O₃;
about 0.0 wt. % to about 5.0 wt. % Na₂O;
about 0.0 wt. % to about 10.0 wt. % ZnO;
about 0.5 wt. % to about 6.0 wt. % P₂O₅; and
about 0.2 wt. % to about 15.0 wt. % ZrO₂.

11. The textured article of claim 1, wherein the glass-based substrate has a composition comprising:
about 60.0 mol % to about 80.0 mol % SiO₂;
about 10.0 mol % to about 20.0 mol % Al₂O₃;
about 4.0 mol % to about 6.0 mol % Li₂O;
about 4.5 mol % to about 12.0 mol % Na₂O, wherein the amount of Na₂O is greater than the amount of Li₂O;
about 0.5 mol % to about 3.0 mol % ZnO;
about 0.9 mol % to about 7.5 mol % B₂O₃; and
about 0.0 mol % to about 10.0 mol % P₂O₅, wherein:
the total amount of B₂O₃, P₂O₅, SiO₂ and Al₂O₃ is about 80 mol % or greater;
the ratio of Li₂O to the total amount of B₂O₃, P₂O₅, SiO₂ and Al₂O₃ is from about 0.065 to less than about 0.074; and
the glass-based substrate excludes glass-ceramic materials and the composition is free of nucleating agents.

12. The textured article of claim 1, wherein the glass-based substrate has a composition comprising:
about 60.0 mol. % to about 70.0 mol. % SiO₂;
about 5.0 mol. % to about 20.0 mol. % Al₂O₃;
about 1.0 mol. % to about 4.0 mol. % MgO;
about 0.5 mol. % to about 10.0 mol. % Li₂O;
about 0.45 mol. % to about 6.0 mol. % P₂O₅;
about 0.0 mol. % to about 15.0 mol. % Na₂O;
about 0.0 mol. % to about 5.0 mol. % B₂O₃;
about 0.0 mol. % to about 1.0 mol. % ZnO;
about 0.0 mol. % to about 0.5 mol. % K₂O;
less than or equal to 16.0 mol. % Alk₂O; and
greater than or equal to 0.0 mol. % to less than or equal to 1.5 mol. % REₘOₙ, wherein the composition satisfies the condition:
0.85≤Alk₂O/Al₂O₃[mol. %]≤1.2, and
wherein:
chemical formulas mean the content of corresponding components in the glass in mol %, Alk₂O is a total sum of alkali metal oxides, Li₂O+Na₂O+K₂O+Rb₂O+Cs₂O, and REₘOₙ is a total sum of rare earth metal oxides, La₂O₃+Y₂O₃+Gd₂O₃+Yb₂O₃+Lu₂O₃+Ce₂O₃+Pr₂O₃+Nd₂O₃+Sm₂O₃+Eu₂O₃+Tb₂O₃+Dy₂O₃+H0203+Er₂O₃+Tm₂O₃.

13. The textured article of claim 1, wherein the glass-based substrate is transparent, colored transparent, opaque, colored opaque, translucent, or colored translucent.

14. The textured article of claim 1, wherein the glass-based substrate has a composition comprising:
about 66 mol % to about 74 mol % SiO₂;
at least about 10 mol % R₂O, wherein R₂O comprises about 9 mol % to about 20 mol % Na₂O;
about 9 mol % to about 22 mol % Al₂O₃, wherein Al₂O₃ (mol %)<R₂O (mol %); and
B₂O₃, wherein B₂O₃ (mol %)-(R₂O (mol %)-Al₂O₃ (mol %))≥2.25 mol %, and wherein the glass is ion exchangeable.

15. The textured article of claim 1, wherein both of:
at least a portion of the textured article has an opacity of greater than about 70%; and
at least a portion of the textured article has a coefficient of friction of from about 0.25 to about 0.4.

16. The textured article of claim 1, wherein at least a portion of the textured article has a cheesecloth-abraded water contact angle of from about 109° to about 114° after being subjected to 400,000 strokes using a cheesecloth.

17. The textured article of claim 1, wherein the textured article is a vehicle part or a portion of a vehicle part.

18. A consumer electronic product, comprising:
a housing comprising a front surface, a back surface and side surfaces;
electrical components at least partially within the housing, the electrical components comprising a controller, a memory, and a display, the display at or adjacent to the front surface of the housing; and
a cover substrate disposed over the display,
wherein at least one of a portion of the housing not including the display comprises the textured article of claim 1.

19. A textured article comprising:
a glass-based substrate comprising a first major surface and a second major surface opposite the second major surface, wherein:
at least a portion of the first major surface is textured and has:
a roughness Rₐ of greater than or equal to about 400 nm; and
an average pitch, wherein a ratio of roughness Rₐ to average pitch is from about 0.01 to about 0.04; and
at least a portion of the textured article has one of the following:
transmittance color coordinates in the (L*, a*, b*) colorimetry system at normal incidence under an International Commission on Illumination illuminant of
L*: about 90 to about 98;
a*: about −0.75 to about 0; and
b*: about −2 to about 0; or
transmittance color coordinates in the (L*, a*, b*) colorimetry system at normal incidence under an International Commission on Illumination illuminant of
L*: about 25 to about 32;
a*: about −0.5 to about 0; and
b*: about −1.5 to about 0.

20. A method of making a textured article, the method comprising:
abrading at least a portion of a first major surface, a second major surface, or both, of a glass-based substrate to form an abraded surface by propelling abrasive particles against the surface; and
etching the abraded surface with an etchant to form a textured glass-based substrate;
wherein the etchant is an aqueous hydroxide solution with a hydroxide concentration of from about 5 wt. % to about 70 wt. %; and
abrading the surface of the glass-based substrate is with an abrasive media having an average diameter of from about 7 microns to about 70 microns.
